(19) United States
(12) Patent Application Publication
(10) Pub. No.: US 2018/0129754 A1
(43) Pub. Date: May 10, 2018

(54) A METHOD AND SYSTEM FOR SEARCHING WITHIN A GRAPH-BASED ARCHITECTURE

(71) Applicant: KNOGNO LTD, London (GB)

(72) Inventors: Simon JONES, London (GB); John HAMPSON, London (GB); Martin COWARD, Monaco (MC); Christopher David SKARDON, Launceston, Cornwall (GB)

(21) Appl. No.: 15/575,525

(22) PCT Filed: May 20, 2016
(86) PCT No.: PCT/GB2016/051472

§ 371 Date: Nov. 20, 2017

(30) Foreign Application Priority Data
May 20, 2015 (GB) 1508630.9

(51) Int. Cl. G06F 17/30

(52) U.S. Cl. CPC G06F 17/30979; G06F 17/30958; G06N 5/04; G06F 17/30398; G06F 17/30448

(57) ABSTRACT

The present invention relates to a computer-implemented method of searching in a set comprising a plurality of entities each entity comprising a graph of nodes containing information related to the entity. The method includes the steps of receiving input at one or more processors from a user to define a plurality of related nodes; one or more processors searching one or more of the graphs by matching nodes of the one or more graphs to the defined nodes; and one or more processors retrieving one or more entities comprising matching nodes that exceed a threshold, or thresholds. A system is also disclosed.

### FIELD OF INVENTION

The present invention is in the field of matching & search engines. More particularly, but not exclusively, the present invention relates to matching/search engines for a graph-based architecture.

### BACKGROUND

An information system comprises information. To provide an effective information system, information stored therein must be usable or retrievable by a user or entity.

There are many different types of information systems. Information systems may provide or define different types of relationships between various information stored within the information system.

One such information system uses a graph ontology to model the relationships between the information which are defined as nodes within a graph or graphs.

In certain applications, it is desirable to retrieve information from graph-based information architectures in response to a search request comprised of various search parameters. Search engines for use in relation to graph-based architectures are used for actuating search requests.

There exist a number of prominent online data systems or social networks which are graph-based or have graph-mediated components, notably Google and Facebook. These systems and networks provide for search capability with search engines where the search request is defined by a sequential list of search terms whose relative importance and inter-dependence may remain arbitrary. Searching these systems with multiple dependent parameters, or with conditionality or ambiguous priority can be difficult or impossible.

There is a desire for an improved method for retrieving information from a graph-based information system.

It is an object of the present invention to provide a method and system for searching within a graph-based architecture which overcomes the disadvantages of the prior art, or at least provides a useful alternative.

### SUMMARY OF INVENTION

According to a first aspect of the invention there is provided a computer-implemented method of searching in a set comprising a plurality of entities each entity comprising a graph of nodes containing information related to the entity, including:

i) receiving input at one or more processors from a user to define a plurality of related nodes;
ii) one or more processors searching one or more of the graphs by matching nodes of the one or more graphs to the defined nodes; and
iii) one or more processors retrieving one or more entities comprising matching nodes that exceed a threshold, or thresholds.

According to a further aspect of the invention there is provided a system for searching in a set comprising a plurality of entities each comprising a graph of nodes containing information related to the entity, including:

One or more user devices comprising an input and a display;

One or more processors configured receiving input at one or more processors from the user device to define a plurality of related nodes, for searching one or more of the graphs by matching nodes of the one or more graphs to the defined nodes and one or more processors retrieving one or more entities comprising matching nodes that exceed a threshold, or thresholds; and

One or more memory configured for storing graphs of nodes representing a plurality of entities.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2a: shows a flow diagram illustrating a method for defining information within a graph-based architecture in accordance with an embodiment of the invention;

FIGS. 2b to 2i: show diagram illustrating an exemplary method for generating options for nodes for use with the method of FIG. 2a in accordance with an embodiment of the invention;

FIG. 3: shows a flow diagram illustrating a method for searching within a graph-based architecture for use with an embodiment of the invention;

FIGS. 4a to 4b: show diagrams illustrating time zone data elements for use with an embodiment of the invention;

FIG. 5: shows a sequence diagram illustrating a method for creating an Onty element in accordance with an embodiment of the invention;

FIG. 5: shows a sequence diagram illustrating a method for creating an Onty element in accordance with an embodiment of the invention;

FIG. 6a: shows a sequence diagram illustrating a method for deleting an Onty element in accordance with an embodiment of the invention;

FIGS. 6b to 6c: show diagrams illustrating deletion of Onty elements for use with an embodiment of the invention;

FIG. 7a: shows a sequence diagram illustrating a method for deleting a chain of Onty elements in accordance with an embodiment of the invention;

FIGS. 7b to 7c: show diagrams illustrating deletion of a chain of Onty elements for use with an embodiment of the invention;

FIG. 8: shows a sequence diagram illustrating a method for updating an Onty element in accordance with an embodiment of the invention;

FIG. 9: shows a diagram illustrating updating of an Onty element for use with an embodiment of the invention;

FIG. 10: shows a sequence diagram illustrating a method for searching within a graph architecture via a website in accordance with an embodiment of the invention;

FIG. 11: shows a sequence diagram illustrating a method for searching within a graph architecture via a long search in accordance with an embodiment of the invention;

FIG. 12: shows a component diagram illustrating a system (a Bot Hoard) for managing matching engines in accordance with an embodiment of the invention;

FIG. 13: shows a component diagram illustrating a search service in accordance with an embodiment of the invention;

FIG. 14: shows a component diagram illustrating a combination of matching engines for performing searches in accordance with an embodiment of the invention;

FIG. 15: shows a flow diagram illustrating a method for multiple matching engines performing a searches in accordance with an embodiment of the invention;

FIGS. 16a to 16g: show diagrams illustrating searching via a complementary inferrer in accordance with an embodiment of the invention;

FIG. 17: shows a sequence diagram illustrating a method for searching via a complementary inferrer in accordance with an embodiment of the invention;

FIGS. 18a to 18e, and 19 to 23: show diagrams illustrating the flow through a user interface for defining a graph in accordance with an embodiment of the invention;

FIGS. 24a to 25f: show screenshots illustrating exemplary user interfaces for defining a graph in accordance with embodiments of the invention;

FIGS. 26 to 32: show diagrams illustrating different matching engines in accordance with embodiments of the invention;

FIG. 33: shows a sequence diagram illustrating a long term search method in accordance with an embodiment of the invention;

FIGS. 34a to 37: show diagrams illustrating a sphere of influence method in accordance with embodiments of the invention; and

FIGS. 38a to 38e: show diagrams illustrating the definition of links or relationships between nodes in accordance with an embodiment of the invention.

### DETAILED DESCRIPTIONS OF PREFERRED EMBODIMENTS OF THE INVENTION

The present invention provides a method and system for searching within a graph-based architecture.

The inventors have discovered that search results can be improved by using a search query constructed of a graph object to search within a graph-based architecture.

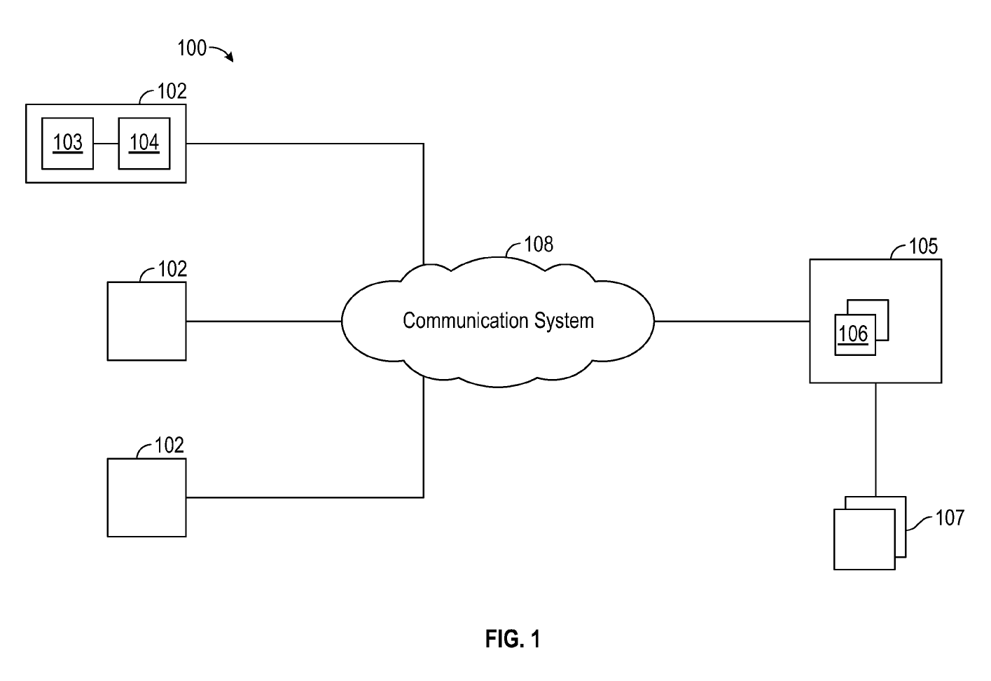

In FIG. 1, a system 100 for defining information within a graph-based architecture in accordance with an embodiment of the invention is shown.

The system 100 may comprise one or more user devices 102.

Each user device 102 includes an input 103 and a display 104. The input 103 may be one or a combination of mouse, touchpad, keyboard, or other means for input (e.g. gyroscopes, audio, etc.). The display 104 may be an LCD or OLED screen. The display 104 and input 103 may be formed of a touch-screen display.

Each user device 102 is configured to provide a user interface to display information on the display 104 and to receive input 103 from the user via the input.

Each user device 102 may include other conventional hardware such as a processor, a memory and a communications module for communicating with other apparatus.

A server 105 is also shown.

The server 105 may include one or more processors 106.

The server 105 may include other conventional hardware such as a communication module for communicating with other apparatus.

The one or more processors 106 may be configured to receive input from the user via the user device 102 to define a plurality of related nodes, to search a plurality of stored graphs using the defined nodes to locate matches, and to retrieve entities comprised the matched graphs from one or more memory 107.

It will be appreciated that in different embodiments each of the one or more processors 106 may be configured to perform separate functionality, or all of the functionality described.

A communications system 108 is also shown. The communications system 108 may be comprised of one or more communications networks, such as cellular networks, wireless networks (such as wifi) or wired networks (such as Ethernet LANs or WANs). The networks may be interconnected.

The user devices 102 and the server 105 may be configured to communicate via the communication system 108.

It will be appreciated that in alternative embodiments, the user device 102 and server 105 may be a part of the same apparatus and be co-located. Alternatively, the one or more processors 106 and one or more memory 107 may be arranged in a distributed hardware architecture and linked via a communications infrastructure.

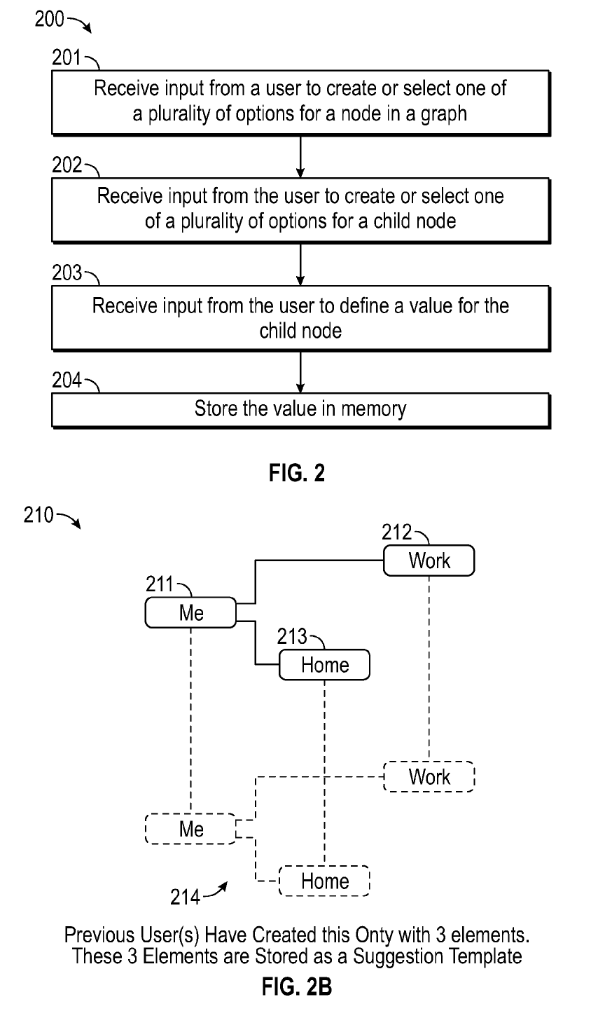

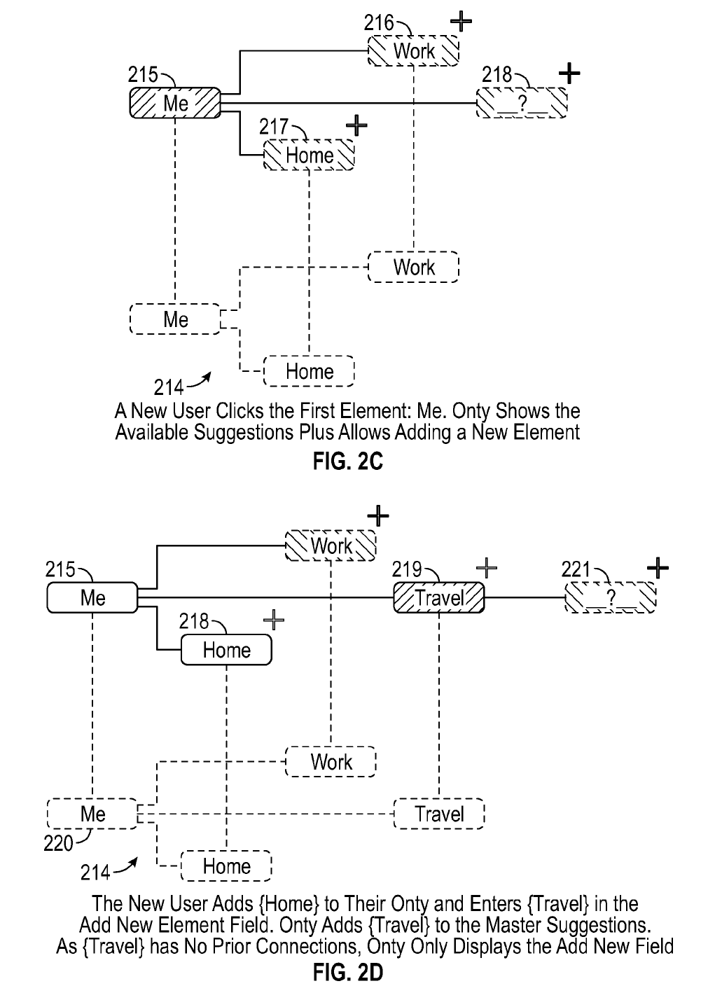

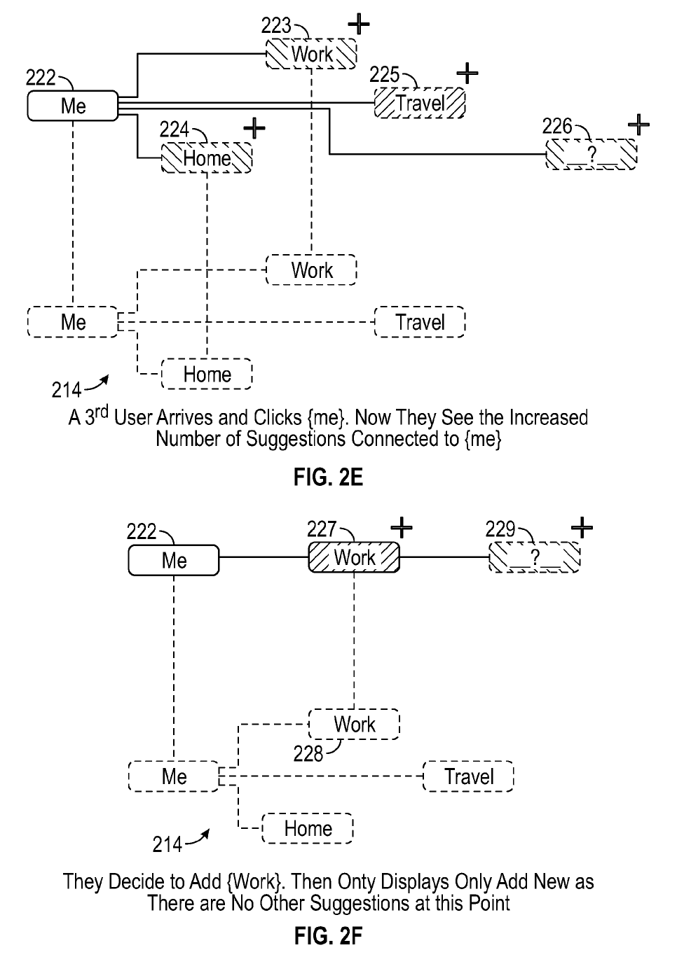

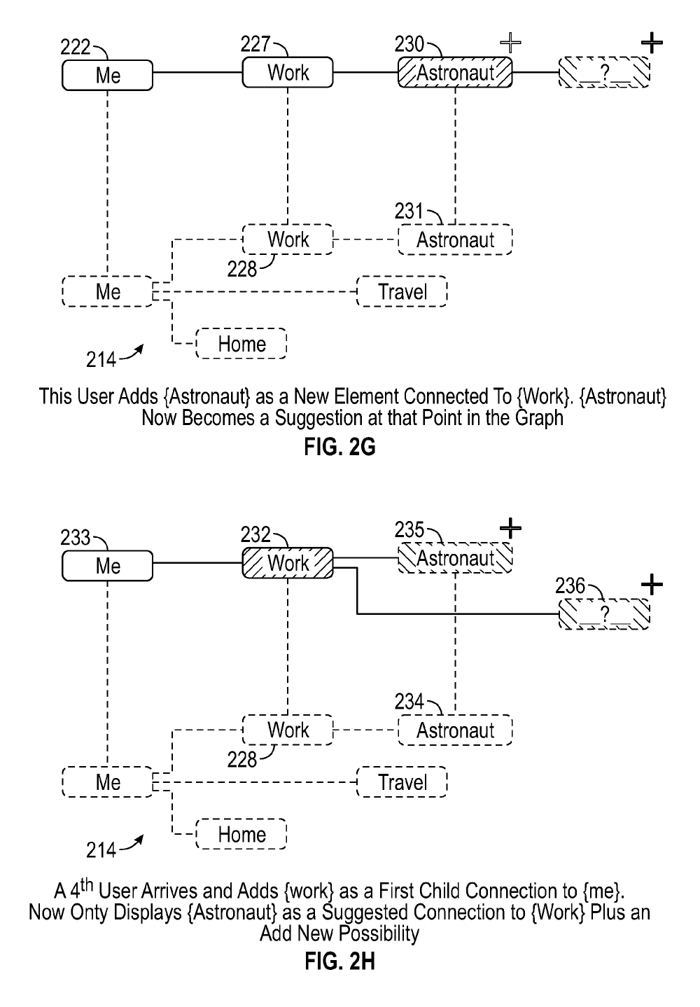

With reference to FIG. 2a, a method 200 for defining information within a graph-based architecture in accordance with an embodiment of the invention will be described.

In step 201, input is received (e.g. at processor 106) from a user (e.g. via user device 102) to create an option or select an option for a node in a graph. A list of least some of plurality of possible options may be displayed (e.g. at the display 104 of the user device 102) to the user to select from. The possible options may be generated (e.g. at processor 106) based upon previous options for corresponding nodes created or selected by other users in other graphs. Corresponding nodes may be determined based upon a correspondence in relationships between the nodes in the other graphs and relationships between nodes in the user's graph.

The list of possible options displayed may be generated based upon frequency of use by other users.

The list of possible options may be displayed as visual elements radially surrounding a parent node in the graph. The user may select the possible options by actuating (e.g. at input 103 at the user device 102) its associated visual element. One visual element radially surrounding the parent node may represent a “new” option. The user may select this new option (e.g. at input 103 at user device 102) and enter information to create the option for the node. During provision of the information, one or more possible options which at least partially match the information may be displayed to enable the user to quick select an option for the node.

In step 202, input is received (e.g. at processor 106) from the user (e.g. via user device 102) to create an option or select an option for one or more child nodes in the graph. A list of least some of plurality of possible options may be displayed (e.g. at display 104 at user device 102) to the user to select from. The possible options may be generated (e.g. at processor 105) based upon previous options for corresponding nodes created or selected by other users in other graphs. Corresponding nodes may be determined based upon a correspondence in relationships between the nodes in the other graphs and relationships between nodes in the user's graph. The list of possible options displayed may be generated based upon frequency of use by other users.

The list of possible options may be displayed as visual elements radially surrounding a parent node in the graph. The user may select the possible options by actuating (e.g. at input 103) its associated visual element. One visual element radially surrounding the parent node may represent a “new” option. The user may select this new option (e.g. at input 103) and enter information to create the option for the child node. During provision of the information, one or more possible options which at least partially match the information may be displayed to enable the user to quick select an option for the child node.

A link may also be specified between the node and the child nodes. In one embodiment, this link may be specified by the system as “related to”—that is, the child nodes are related to their parent node. In another embodiment, the user may modify or specify the link between a parent node and their child nodes (e.g. at user device 102). This link can therefore define the nature of the relationship between the parent node and the child node.

In step 203, input is received (e.g. at processor 106) from the user (e.g. via input 103 at user device 102) to define a value for one or more of the child nodes. The type of input may be defined by the child node. For example, if the child node relates to time (e.g. “at”) then the input type is defined as time and input must be a time value (e.g. 13:00 or 1 pm).

An input form may be displayed to the user in a user interface (e.g. at user device 102). The input form may assist the user in providing a value of a type defined by the child node. For example, if the child node relates to date (e.g. “on”) then the input type is defined as date and the input form may be calendar to enable the user to select a date.

In step 204, the value is stored in a memory (e.g. by server 105 in memory 107). The created/selected options for the node and one or more child nodes may also be stored (e.g. in memory 107).

In one embodiment, the value may be a link to an external data source(s) and dynamically retrieved.

With reference to FIGS. 2b to 2i, a method in accordance with an embodiment of the invention will now be described showing how options may be generated for the method described in relation to FIG. 2a.

In FIG. 2b, a first user has created a graph 210 (called an Onty in the example in FIGS. 2b to 2i) constructed of a me parent node 211, and two child nodes (work 212 and home 213). These elements are stored as a suggestion template or master graph 214.

In FIG. 2c, a second user has a first node—me 215, and a plurality of options (work 216 and home 217) are obtained from the master graph 214 and suggested to the user for a child node. A third option 218 is provided to the second user to, alternatively, create a new option.

In FIG. 2d, the second user selects the home option 217 for a child node 218 to the me node 215. The user also creates a new option (travel) for another child node 219 to the me node 215. It can be seen that because travel does not exist as a child node to the me node 220 in the master graph 214 that the only option provided to the second user is to create a new option 221 for a child node to the travel node 219.

In FIG. 2e, a third user has a first node—me 222, and a plurality of options (work 223, home 224 and now travel 225) are obtained from the master graph 214 (which has been built by the first and second user) and suggested to the third user for a child node. A fourth option 226 is provided to the second user to create a new option for the child node.

In FIG. 2f, the third user selects the work option 223 for the child node 227 to the me node 222. It can be seen from the master graph 214 that there are no child nodes to the work node 228. Therefore, there are no options provided to the second user to select for a child node to their work node 227 except to create a new option 229.

In FIG. 2g, the third user creates astronaut for the child node 230 to the work node 227. This new child node 230 is created within the master graph 214 as a child node 231 for the work node 228.

In FIG. 2h, a fourth user selects work as a child node 232 to their me node 233 and astronaut is obtained from the master graph 214 as a possible child node 234 for the work node 228 and displayed as an option 235 for a child node to the work node 232. The fourth user may also create a new option 236 for this child node.

In FIG. 2i, the fourth user has created a new option—president—for their child node 237 to the work node 232. This new option is added to the master graph 214 as a possible child node 238 for the work node 232.

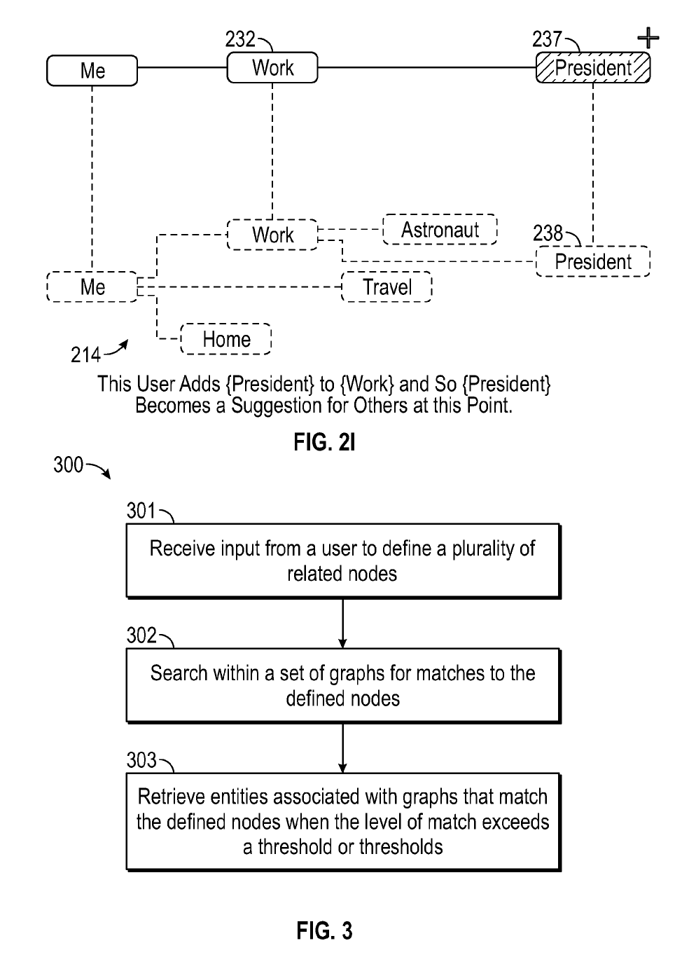

With reference to FIG. 3, a method 300 for searching within a graph-based architecture for use with an embodiment of the invention will be described.

The graph-based architecture includes a set of graphs of nodes. The set of graphs of nodes may be stored in one or more memory (e.g. 107). Each graph may have been defined by the method 200 described in relation to FIG. 2a. In one embodiment, at least some of the graphs may have been generated automatically.

Each graph is associated with an entity. In one embodiment, the entities represent users. In an alternative embodiment, the entities represent a type of information (e.g. a document). It will be appreciated that the graph-based architecture may be adapted to work with any type of entity which is associated with structured information.

In step 301, input is received (e.g. at processor 106) from a user (e.g. via user device 102) to define a plurality of related nodes. The input may be received via a user interface provided on a user device (e.g. 102). The nodes may be related such that the nodes form a graph. In one embodiment, to define the related nodes, the user may create a connected graph of nodes. In another embodiment, to define the related nodes, the user may select (e.g. at a user device 102) a plurality of nodes from a larger predefined graph of nodes. Some or all of these selected nodes may also be connected to one another within this larger graph. The larger predefined graph of nodes may represent an entity. The entity may be related to the user. For example, the entity may comprise information about the user such as name, date of birth, job, interests, etc. The larger predefined graph of nodes may have also been created in accordance with the method 200 described in relation to FIG. 2a.

In step 302, the defined nodes are searched within the set of graphs for matches (e.g. by a processor 106). One or more matching engines may be used to search within the set of graphs. The user may define which matching engines to use and/or parameters for the matching engines to calibrate the closeness of the match (i.e. thresholds). The matching engines may include the following engines:

a) An exact match engine—this engine finds matches by finding those graphs which have connected nodes in same arrangement as the defined nodes;
b) An exact skip match engine—this engine finds matches by finding those graphs which have connected nodes separated by no more than a predefined number of nodes as the defined nodes. The user may be able to predefine the number of nodes before the searching begins;
c) A thesaurus match engine—this engine operates the same as (b) but includes nodes that match synonyms of the defined nodes;
d) A data match engine—this engine operates the same as (b) but matches nodes when their associated values are within a specified range. The user may be able to specify the range;
e) A translation engine—this engine operates the same as (b) but matches nodes that match translations of the defined nodes. The user may be able to define which languages that can be used; and
f) A complementary engine—this engine operates the same as (b) but matches nodes that are complementary to the defined nodes (for example, a node that specifies that something has been “Lost” might be matched to a node that specifies that something has been “Found”).

In one embodiment, the matching engines match the nodes within the graphs via inferences. For example, if a defined node specifies a birth-date, then an age may also be dynamically generated to match to nodes specifying ages. In one embodiment, inferences for a node are not generated dynamically but generated periodically and stored associated with the respective node.

In one embodiment, the nodes within the graphs and/or defined nodes are connected via links (or edges), and a link represents the relationship between a parent node and child node. The matching engines may also utilise the nature of the links between the nodes to locate matches.

In step 303, entities with graphs that match the defined nodes are retrieved (e.g. from a memory 107 by a processor 106) when the level of match exceeds a threshold or thresholds. The threshold(s) may be those defined for the matching engine used. The matching engines may use predefined thresholds. One or more of the thresholds may be provided or modified by the user.

The retrieved entities may be displayed to the user (e.g. at display 104 on user device 102) in real-time as they are located. In one embodiment, only the matching nodes of the retrieved entities are displayed.

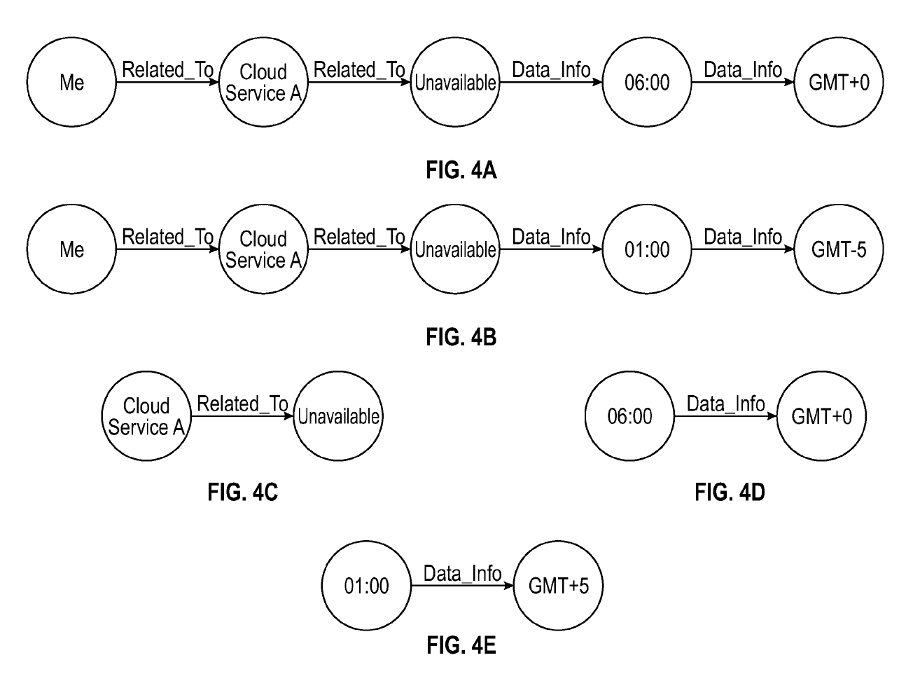

Embodiments of the invention will now be described with reference to FIGS. 4a to 38e.

In these embodiments, the graph architecture is used for providing an information matching network and includes a plurality of graphs. These graphs will be termed Ontys.

There may be two types of Ontys: a User Onty and a Master Onty.

The User Onty represents an entity and contains nodes which relate to that specific entity. For example, the entities may represent human beings and the User Onty may represent a social profile. In this way, the graph architecture may be used to provide a social network.

In this system there will be many User Ontys.

The Master Onty is constructed from nodes in the User Ontys and represents all possible options for a new node from a specific parent node.

The system of these embodiments differs from existing graph-based social networks because each users profile is convoluted with the graph. Contrary to existing social networks, the graph is user defined, flexible and versatile. The system imposes no prior expectations on the user's intentions as regards how the user may wish to describe whatever they wish, or why.

During creation of a User Onty by a user, the possible options for adding nodes to the User Onty are suggested by the system using the anonymous contributions of others to the Master Onty. In this way, an interesting collective, anonymous, self-organising information representation system may be created as an emergent property of the information architecture. Every subsequent user to the previous can benefit from prior input; at any point in their graph they can ‘inherit’ a suggestion or, if so required, contribute something new and so offer a mutation. This may create an interesting combination of collective feedback through anonymous cooperation.

Due to the flexibility provided by the system, a user's profile is richer than typical social networks and can be considered more as a “narrative”.

Users build digital narratives by creating a graph of nodes linked by edges within a user interface provided by the system. The graph is displayed as a radial network comprising the centre node with connected child nodes of a number up to a maximum defined by visual space economy of the display device in question. The number of displayed levels (generations) of the graph is also dictated by display size however this will typically be two, the centre focus node and the next level down.

The graph view includes two types of node, both colour- and size-coded. One type is hints, which are suggestions provided by the system from a frequency selection of the aggregate input of all other users at this point in the graph (see later for a more comprehensive explanation). These hints can be added to the current user's graph and at such point then they become the second type: a user element in that user's individual graph. When the desired term does not feature in the hints, the user may enter a new term. At such point the new term becomes an element of their graph and furthermore a hint in all other users graphs. If the system recognises the new term being entered as a non-displayed hint (by limit of the frequency of use selection) then this is automatically suggested as the hint in question.

The links connecting nodes default to ‘related to’ or associate numerical data to a node (metrics, dates, times and location coordinates). Users may however narrow the semantic content of any link type and define such to be, for instance, ‘want’, ‘seek’, ‘offer’.

When new terms are entered, the user may require to restrict this term from featuring amongst the anonymous hints for others, for example in the case of their name. In such cases the user can set a user element to be hidden. Hidden nodes will not then be suggested for addition to all other users at that point in the graph.

Users may navigate through their ONTY by clicking on a child to drill down in that direction. In such case the selected child becomes the central node with focus and the next generation of connected nodes are displayed. To return back they click the centre node. Alternatively users may use a map view to display their entire graph and navigate to any point within.

Users can delete individual leaf nodes or can agree (when challenged) to delete the current node and all its descendants (if selecting to delete a node with children).

For any individual node or collection of nodes in a tree, if the current delete action results in the removal of the final use of that node/node collection across the user population, then those nodes drop off the master hint nodes graph.

Nodes or collections of nodes can be moved from one parent to another by dragging the lowest level member of that tree from one location to another on the graph, by dragging the graph subtree on to its intended new parent.

Users can search for elements within their graph, including synonyms.

As well as lexical elements, users can add elements to their graph denoting numerate measurements, dates, times or the coordinates of physical locations. All such numerate elements do not contribute to the master graph or then become hints for other users. They are labelled DataOntyElements.

When a user adds elements to their graph that require accompanying data, they can select to link a data element to that term. In such case the system offers the choice of 4 data capture dialogues: metric/date/time/location. In many instances, typing the associated concept, e.g. weight, will trigger the option to provide the measurement in question using the appropriate input dialogue.

Once a data entry dialogue type is selected (or suggested), the user can enter the relevant data and select the unit system they require. The system stores the user-defined measurement-unit pair and also the SI equivalent if this is differs from that given.

In the case of a metric data element, for example, the user may wish to select/add a node called ‘length’ and then use the metric data type dialogue to associate ‘50’ & ‘metres’ with that node.

Alternatively, a user can add a date value or a date range to an element of their graph by selecting such data from a calendar dialogue. Dates are simple integer dates with no implied time zone reference.

If so desired, users enter the time required from a clock dialogue. Users can elect to store a matchable time of day as invariant across time zones, for when the local time of day is what matters, irrespective of the user's time zone. Alternatively, users should assign a corresponding time zone to any given time of day. This is necessary when matching an instance of time (e.g. a deadline) is what counts across all time zones concerned. When time zones are given, time of day will be stored in GMT.

Users may associate a location data element to an element of their graph by selecting a point on the map on the (searchable) cartographic dialogue. This results in the system storing the geographic coordinates of that location (and not any associated place name). When users add nodes to their ONTY containing place names such as ‘London’ or ‘New York’ these have no associated coordinates and assert only their semantic value. Such use of place names is included in the Master Onty hint system.

The system reserves another type of node—dynamic—for cases when the user wishes to incorporate an external, linked, and therefore variable, element into their graph. This data source is therefore elsewhere on the internet and must be linkable and, for instance, interpretable either from its position on the source page or via identification as an xml element. Like other DataOntyElements, dynamic nodes do not contribute to the Master Onty.

In one embodiment, a user can use their individual graph—their user Onty or uOnty—to perform a search for matches across all other users' uOntys. Hence a user can look for matches with other users based on the contents of their own uOnty. The searching user selects any subset of their uOnty to construct a search Onty (sOnty). The system then analyses the entire database for matching components of other users' uOntys to this sOnty.

To search for matches, the system employs an extensible number of matching modules, or MatchBots. Each MatchBot specialises in seeking matches in a different manner, e.g. word semantics or event coincidence. Different types of matching components may include, but are not limited to:
i) Exactbot: examines nodes across user graphs for equivalence
ii) Skipbot: allows for flexibility in narrative construction between users by introducing variability in the number of steps between matching nodes across 2 different user graphs.
iii) Therabot: Accounts for synonymy between users
iv) Linguabot: Extension of synonymy to language translation
v) Databot: Metric/Date/Time/Location matching

Different MatchBots can be combined into a MatchBox to perform an overall match based on different subcomponents. The system presents a default MatchBox configuration to perform searches. This is a reasonable combination of the set of MatchBots available at that time. As the total number of MatchBots are expected to increase with time, constant tuning of the default MatchBox matching engine is also expected. In addition to the default MatchBox, search architecture customisation is available for those users who wish to experiment with their own matching procedures.

When a user effects a search, the MatchBox proposes connections between the searching user and one or more possible matches. Both the searcher and searched can then inspect the proposed match by viewing the intersection—but only the intersection—between the searcher's sOnty and the target's uOnty. The pair may now communicate using integrated instant messaging. If three messages are exchanged then a bind is created between those two users based on that sOnty.

As such, the sOnty and its match(es) form the ‘switchboard’ that enables connections between any pair or collection of user pairs. Proposed connections may be rejected or the corresponding user blocked at any stage.

Users can define and vary the precision of the MatchBots in order to tweak the filter of results. Any numerical or range based element in the sOnty can be assigned a tolerance or margin of error in various matching subroutines.

Semantic tolerance and narrative flexibility can be adjusted by altering the maximum number of element to element hops between any matching term in one user's graph compared to that of any other.

In some cases, to produce useful matches, supplementary information may have to be inferred from that given by the users in question. In such cases there may be an information gap between the actual declared data in a user's Onty and the internalised, logical or deducible information that user may assume is understood, either by the system, or by any prospective matching user. For example, a user may provide a DOB and assume the system will be ‘aware’ of their age. The system in this and similar cases employs an Additive Inferer to add the missing information to the uOnty in question.

Other logical inferences that the system may have to make in order to augment the given uOnty with all necessary information could be for example to infer the date range period a certain user may intend when declaring a particular season, given their location hemisphere.

Moreover, binds between graph-object owners may depend on complementarity as well as similarity. Complementary matching is driven by inferring potential relationships between two user graphs that go beyond that explicitly declared, just as one can infer a positive and negative electrical charge attract. For example, in a dating context, a hetero female user would seek the complementary male users.

When any pair of users create a bind by accepting a connection proposal, or reject/block that proposal, this represents a piece of information. The matchbots can store this information: the components of the sOnty, matched uOnty and the users concerned, plus the acceptance/rejection outcome. Over time the matchbots can use this information to improve on the match proposal behaviour.

As searching or matched users accept valid binds, converse and do not block each other, the matchbots can again store this information and use it to accrue a reliability rating for each user on the system. This in turn they will use to weight the higher reliability rating users above others in match proposals. Once a conversation is in progress, any individual message may then be flagged as being of potentially nefarious and requiring inspection. Both these mechanisms contribute to the bottom-up self-policing nature of the system.

Directed searches can be one shot or the searcher can direct them to persist and in such case they may trigger new match proposals when relevant novel user data is provided by a potential match partner. Hence the searching user can select a frequency at which they wish the sOnty search in question to run, from daily upwards. Hence if new matching uOnty data comes on to the system at a future date then this will get picked up by a persisting scheduled search and trigger notification to the users concerned.

### System Structures

Exemplary structures for the system above will now be described.

### Ontys

Onty is the collective noun for the Onty Elements.

Master Onty (mOnty)

The mOnty is the collection of Master Onty Elements (MOEs) in the system. There should be no replication in the mOnty, each element is unique. Measurements, Dates, Times, Latitude/Longitude pairings (DOE values) should not be stored in the mOnty. All elements in the mOnty are lowercase, and this is set regardless of the case of the uOnty.

User Onty (uOnty)

The uOnty is the collection of User Onty Elements (UOEs) for a given user.

### System Elements

System elements are elements used throughout the system itself, they're generally augmented when passed out to an API call, and simplified for creating. This section details the internal elements. The section on API Elements below provides information on the elements passed in and out of the API.

There are 3 types of Onty Element, the User Onty Element (UOE), the Master Onty Element (MOE) and the Data Onty Element (DOE).

### Master Onty Element

The MOE represents an element that has either been seeded or generated when a user creates their UOE. Collectively they are the Master Onty (mOnty).

Properties

| Name | Type | Description |
|---|---|---|
| ElementId | Guid | A unique identifier for the MOE. |
| IsPermanent | Boolean | Whether or not this MOE can be deleted via the |
| | | API, if true, then this element will always exist |
| | | in the mOnty. Generally used for Seed |
| | | elements. |
| Value | String | The value of the MOE, this is just a |
| | | lowercase string. |
| CreatedOn | DateTime | The point the MOE was created. |

### User Onty Element

UOEs represent user entered data. Together they form a User's Onty.

Properties

| Name | Type | Description |
|---|---|---|
| ElementId | Guid | A unique identifier for the UOE. |
| Value | String | The value of the UOE, this is just a lowercase |
| | | string. |
| IsHidden | Boolean | Whether or not the UOE is private (true) or |
| | | note (false) |
| IsInferred | Boolean | Whether or not the UOE has been created |
| | | by inference. |
| CreatedOn | DateTime | The point the UOE was created. |

### Data Onty Elements (DOE)

Data elements are elements that store information other than the value of a UOE, for example, a user might put the value of ‘Brighton’ into their UOE, and then use the DOE to specify the actual location using Latitude/Longitude.

Nine types of data elements in the system will now be described. It will be appreciated that the system may include one or more of these data element types:

### 1. Date Data Onty Element (DDOE)

The date element is just a date, with no time information stored.

Properties

| Name | Type | Description |
|---|---|---|
| ElementId | Guid | A unique identifier for the DDOE. |
| DataElementType | String | A string representing the type of the |
| | | element. |
| IsInferred | Boolean | Whether or not the DDOE has been |
| | | created by inference. |
| Day | Integer | The day the DDOE represents |
| Month | Integer | The month the DDOE represents |
| Year | Integer | The year the DDOE represents |
| DayOfWeek | Enum | The Day of the Week that the DDOE |
| | | represents |
| CreatedOn | DateTime | The point the DDOE was created. |

### Example JSON

{
“StartDate”:“2014-03-30”
}

### 2. Time Data Onty Element (TDOE)

The time element is just a time, with no date information stored.

Properties

| Name | Type | Description |
|---|---|---|
| ElementId | Guid | A unique identifier for the TDOE. |
| DataElementType | String | A string representing the type of the |
| | | element. |
| IsInferred | Boolean | Whether or not the TDOE has been |
| | | created by inference. |
| Hours | Integer | The hours the TDOE represents |
| Minutes | Integer | The minutes the TDOE represents |
| Seconds | Integer | The seconds the TDOE represents |
| Milliseconds | Integer | The milliseconds the TDOE represents |
| CreatedOn | DateTime | The point the TDOE was created. |

### Example JSON

{
“StartTime”:“14:34:12”
}

### 3. Measurement Data Onty Element (MDOE)

The measurement elements are for storing any SI (International System) units. The units are defined by the user (for example Centimetres, Centigrade, Stones) and stored in the base SI unit, so if someone stored −273.15° C. the underlying structure would store the actual value entered by the user and 0° K as well.

Should the user want to store some other form of measurement, they can simply add their own user defined types and they will be stored with the base unit also being the user defined type (no conversion to a base SI unit as none would be known).

Properties

| Name | Type | Description |
|---|---|---|
| ElementId | Guid | A unique identifier for the MDOE. |
| DataElementType | String | A string representing the type of the |
| | | element. |
| IsInferred | Boolean | Whether or not the MDOE has been |
| | | created by inference. |
| SiUnit | Double | The SI Unit of the MDOE. This is set |
| | | automatically when the MDOE is created. |
| SiValue | Double | The SI Value of the MDOE. This is set |
| | | automatically when the MDOE is created. |
| Unit | Double | The User entered Unit the MDOE |
| | | represents. This could be the same as the |
| | | SiUnit property. |
| Value | Double | The User entered Value the MDOE |
| | | represents. This could be the same as the |
| | | SiValue property. |
| CreatedOn | DateTime | The point the MDOE was created. |

### Example JSON

```
{
  “Value”:“10”,
  “Unit”:“Yards”,
  “SiUnit”:“Metres”,
  “SiValue”:“9.14400”
}
```

### 4. Location 2D Data Onty Element (L2DDOE)

The location element is an element with Latitude and Longitude properties.

Properties

| Name | Type | Description |
|---|---|---|
| ElementId | Guid | A unique identifier for the L2DDOE. |
| DataElementType | String | A string representing the type of the |
| | | element. |
| IsInferred | Boolean | Whether or not the L2DDOE has been |
| | | created by inference. |
| Latitude | Double | The Latitude the L2DDOE represents |
| Longitude | Double | The Longitude the L2DDOE represents |
| CreatedOn | DateTime | The point the L2DOE was created. |

### Example JSON

```
{
  “Latitude”:“10.2245”,
  “Longitude”:“5.4363”
}
```

### 5. Location 3D Data Onty Element (L3DDOE)

The location 3D data onty element represents a point in 3-dimensional space.

Properties

| Name | Type | Description |
|---|---|---|
| ElementId | Guid | A unique identifier for the L3DDOE. |
| DataElementType | String | A string representing the type of the |
| | | element. |
| IsInferred | Boolean | Whether or not the L3DDOE has been |
| | | created by inference. |
| Latitude | Double | The Latitude the L3DDOE represents. |
| Longitude | Double | The Longitude the L3DDOE represents. |
| Ellipsoid | Double | The Ellipsoid the L3DDOE represents. |
| CreatedOn | DateTime | The point the L3DDOE was created. |

### 6. Vector Data Onty Element (VDOE)

A VDOE can be used to represent a vector in terms of magnitude and direction, usually these will be part of a Journey or similar.

Properties

| Name | Type | Description |
|---|---|---|
| ElementId | Guid | A unique identifier for the VDOE. |
| DataElementType | String | A string representing the type of the |
| | | element. |
| IsInferred | Boolean | Whether or not the VDOE has been |
| | | created by inference. |
| Magnitude | Double | The magnitude of the Vector. |
| MagnitudeUnit | String | The Units of Magnitude. |
| Direction | Double | The bearing (in degrees) of the Vector. |
| CreatedOn | DateTime | The point the VDOE was created. |

### 7. Time Zone Data Onty Element (TZDOE)

The TZDOE represents a specific Time Zone for an element. A TZDOE is a special class of DOE that is generally attached to another DOE, (in this case a Time Data Onty Element, see Onty Elements document), though there is no restriction on what it can be attached to.

### EXAMPLES

User A is looking for someone to talk to about a cloud service that had a failure at 4:45 GMT. User A knows when it happened for them, and so creates their Onty as shown in FIG. 4a.

User B is also looking for someone to talk to about it, they're based in the US (East Coast), but haven't added any location data, so they add to their Onty as in FIG. 4b.

Now, when either of them searches for the nodes shown in FIG. 4c.

They will match, as the system will be able to tell that User A's nodes in their Onty as shown in FIG. 4d.

Is a match for User B's nodes in their Onty as shown in FIG. 4e.

Properties

| Name | Type | Description |
|---|---|---|
| ElementId | Guid | A unique identifier for the TZDOE. |
| DataElementType | String | A string representing the type of the |
| | | element. |
| IsInferred | Boolean | Whether or not the TZDOE has been |
| | | created by inference. |
| TimeZone | TimeZone | The time zone represented. |
| CreatedOn | DateTime | The point the TZDOE was created. |

The TimeZone property can be either a valid Time Zone (GMT+7 for example) or None, Invariant, or Locked. Locked would mean any searches would need to be exact matches, Invariant and None are similar in effect, and mean that the Time Zone can be ignored.

### 8. Dynamic Data Onty Element (DyDOE)

DyDOE's are special versions of the other Data Onty Elements, where the value is dynamically updated, an example would be something like an ‘Age’ node which has an MDOE of {“Unit”:“Years”, “Value”:“25”} which is valid this year, but would be ‘26’ next year.

### Properties

A DyDOE has the same properties as a particular version of the DOE it's representing, but also has extra properties:

| Name | Type | Description |
|---|---|---|
| IsDynamic | Boolean | If true this is a dynamic element, false |
| | | otherwise. |
| DynamicFormula | String | A string representing the formula to be |
| | | applied. |
| DynamicSchedule | TimeSpan | Represents the frequency the property |
| | | should be updated (yearly, monthly etc). |

### 9. Linked Data Onty Element (LnkDOE)

An LnkDOE provides a way to link to external sources, (such as the UK Met Office or Magic Seaweed) to be able to pull data without having to manually type it. As an example, a user might have forgotten the surf conditions when they were away on a particular day, and they can import the data from Magic Seaweed and save it to their own Onty.

### Properties

An LnkDOE has the same properties as a basic DOE, but also has these extra properties:

| Name | Type | Description |
|---|---|---|
| Source | String | Typically a URL, or Onty defined friendly |
| | | name for the source. |
| SourceParams | String | Data typically as JSON, but could be |
| | | any form the source requires |
| SourceRetrieved | DateTime | The Date and Time the data was retrieved. |
| SourceValue | String | The value returned from the source. |

The source could be a website, or it could be another element in the users Onty itself.

### API Elements

These are the elements crafted by a client to POST or PUT or DELETE from the API, and the shape of the responses in GET, POST, PUT and DELETE cases.

Unlike the System Elements there are (broadly) only two types of element, the Master Onty Elements are not returned to the User.

### Creating a New UOE

When adding a UOE to a user's onty, the element details and any data elements are sent along at the same time.

Properties

| Name | Type | Description |
|---|---|---|
| Value | String | The value entered by the user for this Onty |
| | | Element. |
| LinkedFrom | Guid | The element this new one is to be attached |
| | | to (the previous/parent element). |
| IsHidden | Boolean | Whether the element is hidden (private) or not. |
| | | If true the element is private, false otherwise. |
| Data | Data | Any data element information see 0 |
| | Element[ ] | |

### Example JSON

```
{
  “LinkedFrom”: “00000000-0000-0000-0000-000000000000”,
  “Value”: “job”,
  “IsHidden”: “false”,
  “Data”: [{
    “Type”: “Location”,
    “Values”: {“Latitude”:“0.3333”, “Longitude”:“0.66666”}
  }]
}
```

### Data Elements

The same five types as outlined in above, but they use a simplified format for adding new data.

### General

All elements are added with two properties, Type which defines the type of the data element being added, and Values which define the properties.

### Date

To add a DDOE the type is set to Date and the Values must contain at least StartDate but it can also include EndDate to represent a date range.

| Name | Type | Description |
|---|---|---|
| StartDate | String | [Required] A date in the ISO-Format |
| | | (yyyy-MM-dd) |
| EndDate | String | A date in the ISO-Format (yyyy-MM-dd) |

### Time

To add a TDOE the type is set to ‘Time’ and the Values must contain at least StartTime but it can also include End Time to represent a time range.

| Name | Type | Description |
|---|---|---|
| StartTime | String | [Required] A time in the 24 hour format |
| | | (HH-mm-ss) |
| EndTime | String | A time in the 24 hour format (HH-mm-ss) |

### Measurement

To add a MDOE the type is set to ‘Measurement’ and the Values has to include the Unit and Value properties.

| Name | Type | Description |
|---|---|---|
| Unit | String | This can be any unit a user wants. |
| Value | Double | A double representing the value of the measurement. |

### Location (2D and 3D)

To add a L2DDOE or an L3DDOE the type is the same ‘Location’, if only the Latitude and Longitude values are set then you get a 2D element, if Ellipsoid is also set, you'll get a 3D element.

| Name | Type | Description |
|---|---|---|
| Latitude | Double | A double representing the Latitude |
| Longitude | Double | A double representing the Longitude |
| Ellipsoid | Double | A double representing the Ellipsoid |

### Multiples

Any UOE can have multiple data elements attached, simply add all the elements to the Data property of the UOE.

### Example JSON

```
“Data”: [
  {
  “Type”: “Location”,
  “Values”: {“Latitude”:“0.3333”, “Longitude”:“0.66666”}
  },
  {
  “Type”: “Measurement”,
  “Values”: {“Unit”:“Metre”, “Value”:“10”}
  }
]
```

In this JSON example we have two Data elements, one Location and one Measurement.

### Deleting a UOE

When deleting a UOE all that is required is the element's ID.

Properties

| Name | Type | Description |
|---|---|---|
| ElementId | Guid | The element to be deleted |

### Example JSON

{
“ElementId”:“00000000-0000-0000-0000-000000000000”
}

### Updating a UOE

A UOE can have three properties updated, the Value property, the IsHidden property (whether or not the element is private—in terms of restricted from the master ONTY), and the Data Elements property. All three can be updated at the same time, or just one.

Properties

| Name | Type | Description |
|---|---|---|
| ElementId | Guid | [REQUIRED] The element to be updated. |
| IsHidden | Boolean | Whether or not the element is private. |
| Value | String | The new value for the element. |
| Data | Dictionary<string, | New data elements for the element. |
| | DOE> | |

If any of the properties are left as null, it is assumed that they are not being changed.

### Example JSON

```
{
  “ElementId”: “00000000-0000-0000-0000-000000000000”,
  “Value”: “job”,
  “IsHidden”: “false”,
  “Data”: [{
    “Type”: “Location”,
    “Values”: {“Latitude”:“0.3333”, “Longitude”:“0.66666”}
  }]
}
```

### Search API Elements

There are two main elements for searching, the Query that is used to create the search, and the Results which contain the results.

### Query

A Query contains everything the bots need to be able to search in the system.

Properties

| Name | Type | Description |
|---|---|---|
| Id | Guid | A system generated ID for the query. |
| Name | String | A user-defined friendly name for |
| | | the query. |
| Elements | QueryElement[ ] | The elements being searched for. |
| BotNames | String[ ] | Names of the bots to use to search. |
| SearchPa- | Dictionary < String, | Parameters for the bots (keyed by the |
| rameters | Search Parameter[ ]> | bot name). |
| QueryCreated | DateTime | The date and time the query was created. |

### Stored Search

A Stored Search contains all the information about the search that was made, and the results.

Properties

| Name | Type | Description |
|---|---|---|
| Id | Guid | A system generated ID for the query. |
| Name | String | A user-defined friendly name for the |
| | | query. |
| Query | Query | The Query searched for. |
| LastCompleted | DateTime? | The last time the search was run. |
| SearchResults | StoredSearchRe- | The results from each time the |
| | sults[ ] | search was run. |

### Stored Search Result

A Stored Search Result (SSR) contains information about the specific search instance.

Properties

| Name | Type | Description |
|---|---|---|
| TimeStampUtc | DateTime? | The time the results were |
| | | found. |
| Results | Search Results | The results. |
| QueryComple- | QueryComple- | Information about the |
| tionInformation | tionInformation | result. |

### Search Results

The Search Results object wraps the results with a status message and any other messages returned from the system (including bots).

Properties

| Name | Type | Description |
|---|---|---|
| Results | Results[ ] | The results from bot. |
| Status | String | The status of the search. |
| OtherMessage | String | Other messages about the search. |

### Results

The results object represents the results from all the bots that were used in a particular search.

Properties

| Name | Type | Description |
|---|---|---|
| AllResults | Result[ ] | The individual results from the bots. |

### Result

A result object represents the result from a specific bot.

Properties

| Name | Type | Description |
|---|---|---|
| BotName | String | The name of the bot that got the results. |
| UserId | String | The user id of the user who matched against. |
| Searchld | Guid | The search Id of the search these results |
| | | are for. |
| MatchedOn | Sim- | The elements matched on. |
| | pleOntyEl- | |
| | ement[ ] | |

### Query Completion Information

The Query Completion Information (QCI) object contains the information about whether or not a search has completed, when it completed, but not the actual results.

Properties

| Name | Type | Description |
|---|---|---|
| IsComplete | Boolean | Whether or not the search has completed. |
| Status | String | Any status messages. |
| CompletedAt | DateTime? | The date & time the search completed. |
| SearchId | Guid | The search ID of the search this QCI |
| | | relates to. |

### System Operations

Exemplary operations provided by the system will now be described:

### Sd Create Onty Element

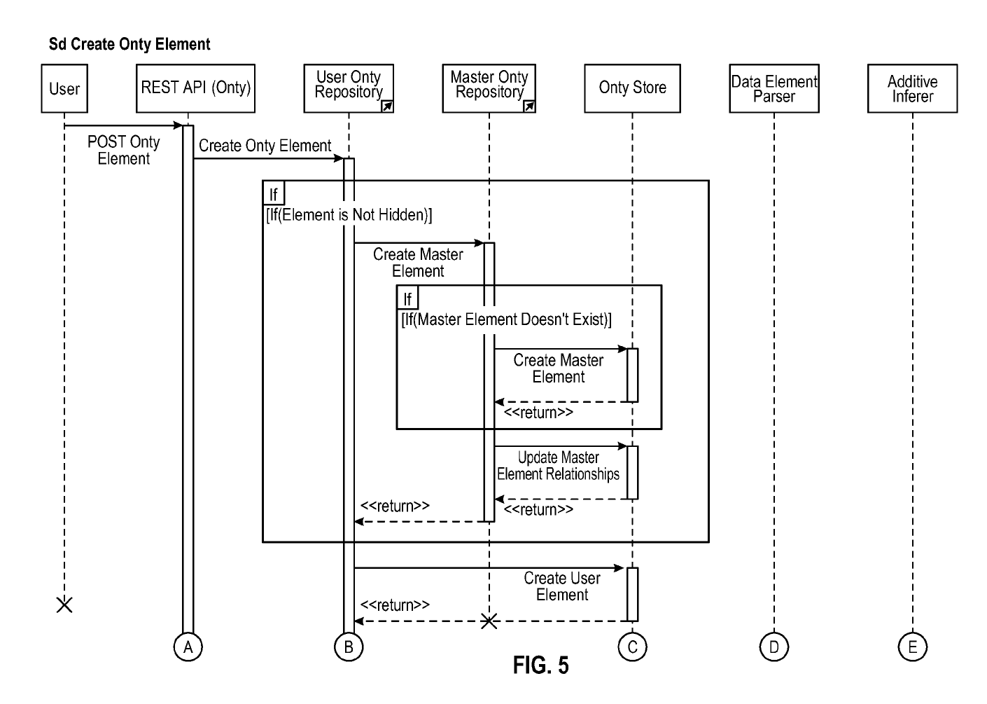

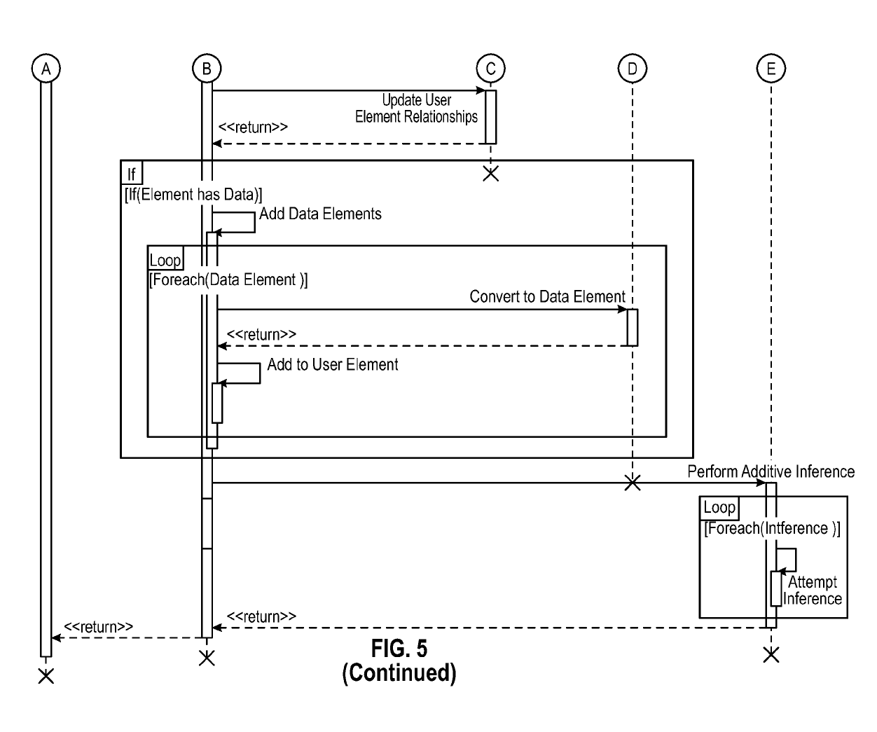

The sd Create Onty Element diagram shown in FIG. 5 displays the flow for a user creating a User Onty Element.

This process is asynchronous.
1. A web page is displayed to a user on their web browser which provides a GUI for enabling the user to define their uOnty.
2. The user selects the button to add an Onty element to their existing Onty. They enter a value for the element and then decide if it is to be a private element (visible only to them) or public (default—visible to all).
3. The details of the element are sent to the Onty API.
4. If the user has made the element public (i.e. not private)
   a. The Value is passed to the MasterOntyRepository which creates a new element in the Onty Store, or finds an existing element with the same value.
   b. The master element is linked (via a RELATED_TO edge) to the equivalent previous master element that the LinkedFrom property relates to.
5. A user element is then created in the Onty Store, if a Master Element Identifier is available (from the previous step) then the identifier is attached to the element.
6. If any data elements were supplied, they are added to the User element.
7. The element value is passed to the Additive Inferers which parse the value to see if any inferences can be made.
8. The newly created UOE ID is then returned.

### Sd Delete Onty Element

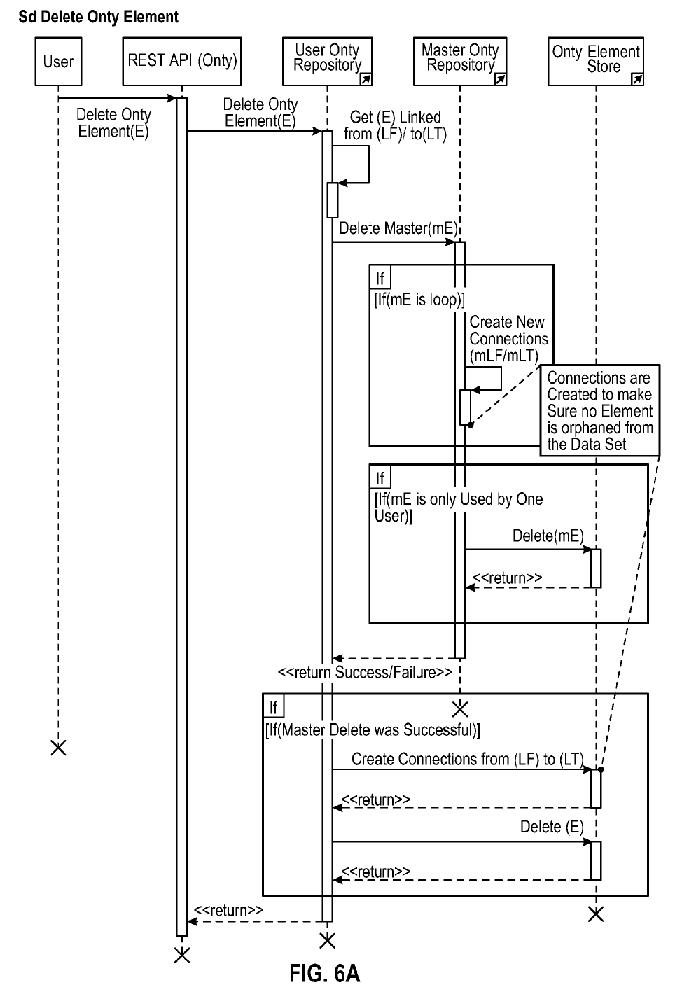

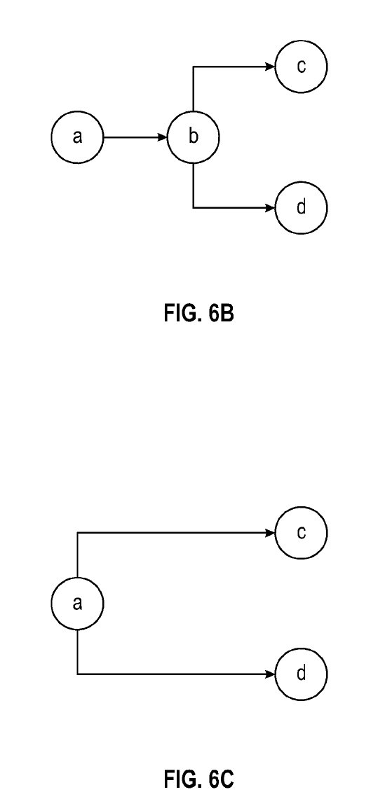

The sd Delete Onty Element diagram shown in FIG. 6a displays the flow for a user deleting a User Onty Element.

This process is asynchronous.
1. A web page is displayed to a user on their web browser, proving a GUI for enabling the user to delete a UOE from their uOnty.
2. The user selects a UOE in their uOnty and selects the delete icon.
3. The ID of the element to be deleted is sent to the Onty API
4. The master version (mE) of the UOE is deleted,
   a. New relationships are made between the elements that were before as shown in FIG. 6b and after as shown in FIG. 6c the mE.
   b. If the mE is not in use in any other users uOnty then it is deleted, otherwise it is left in the mOnty.
5. If step 4 fails, then the UOE isn't deleted, else
6. New relationships are made between the elements that were before and after the UOE (in the same way as in FIG. 6b and FIG. 6c above).
7. A success/fail response is returned to the GUI, which updates accordingly.

### Sd Delete Onty Element Chain

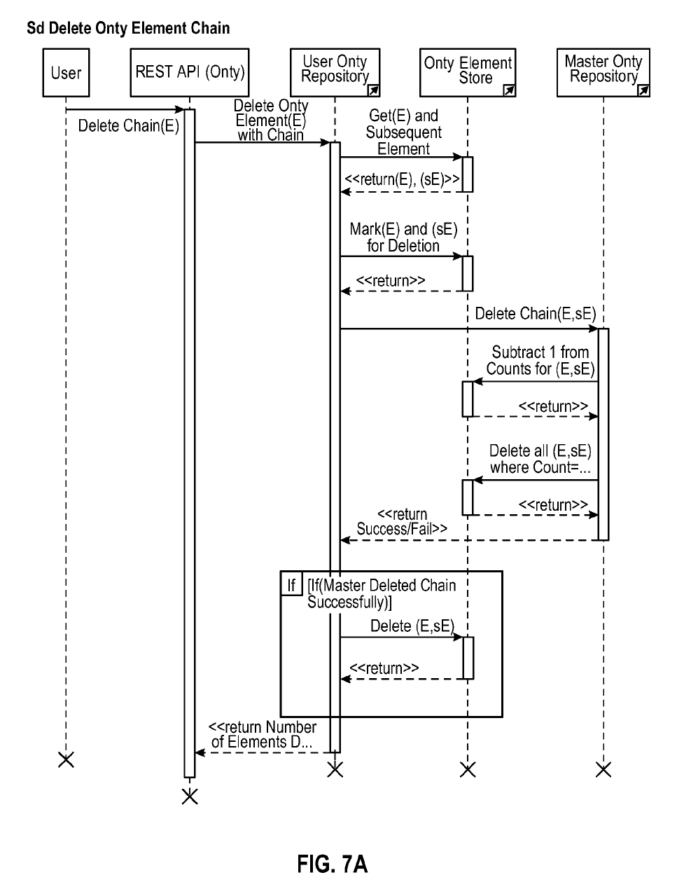

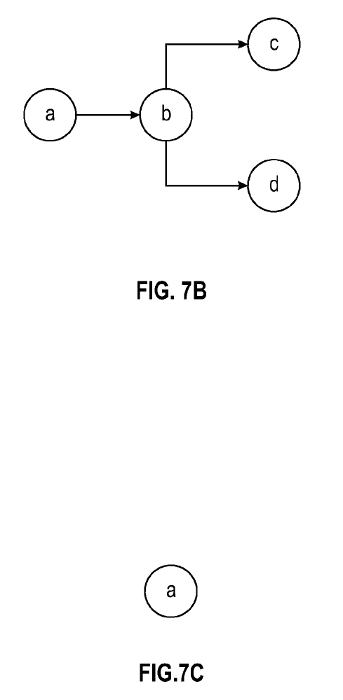

This method as shown in FIG. 7a differs from the sd Delete Onty Element method as it deletes all the subsequent elements as well as the element requested.

This process is asynchronous.
1. A web page is displayed to a user on their web browser, proving a GUI for enabling the user to delete a UOE from their uOnty.
2. The user selects a UOE in their uOnty and selects the delete icon.
3. The ID of the element to be deleted is sent to the Onty API
4. The master version (mE) of the UOE is deleted,
   a. If none of the subsequent elements are in use by other uOntys—the subsequent elements are deleted (e.g. before deletion as shown in FIG. 7b and after deletion as shown in FIG. 7c).
   b. If the elements are in use by other uOntys—the deletion of those MOEs is done in the same way as in the Delete Onty Element. If the mE is not in use in any other users uOnty then it is deleted, otherwise it is left in the mOnty.
5. If step 4 fails, then the UOE isn't deleted, else
6. All subsequent elements from the element to be deleted onwards are deleted (see FIG. 7b and FIG. 7c).
7. A success/fail response is returned to the GUI, which updates accordingly.

### Sd Update Onty Element

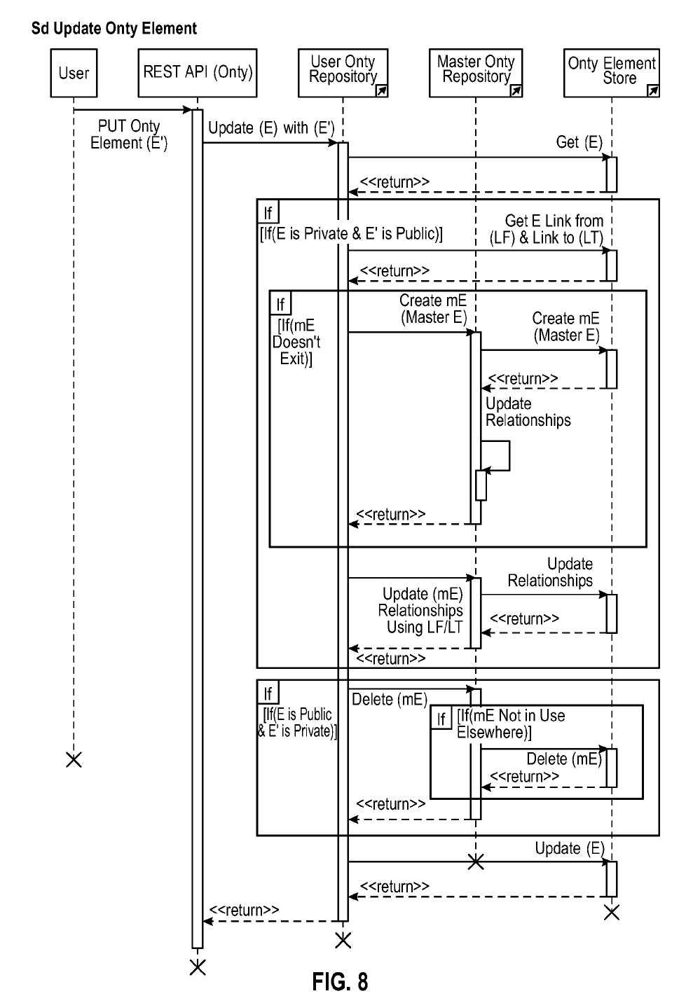

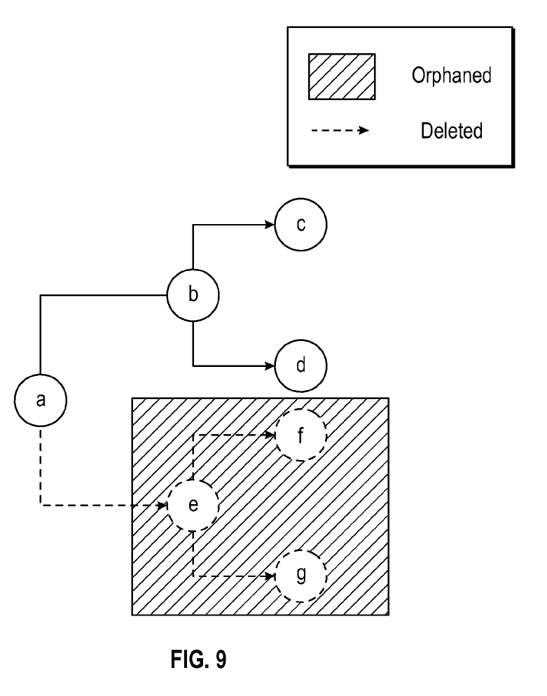

The sd Update Onty Element diagram shown in FIG. 8 shows the process by which a user can update a UOE in their uOnty.

This process is asynchronous.
1. A web page is displayed to a user on their web browser, proving a GUI for enabling the user to update a UOE from their uOnty.
2. The user selects a UOE in their uOnty and selects the update icon.
3. The user supplies a new value for the UOE.
4. The update (E′) is sent to the API via a PUT request.

The below sections follow on from above:

### Private UOE Staying Private

1. The UOE is updated in the Onty Store and the success/failure response is passed to the user.

### Private UOE Becoming Public

1. A check is made to see if a Master Element (mE) exists within the mOnty.
2. If it doesn't exist:
   a. A new mOnty element is created
   b. The MOE is attached to the correct precursor elements (as defined by the uOnty)
3. If it does exist:
   a. The MOE is attached to the correct precursor elements (as defined by the uOnty)
4. The UOE is updated in the Onty Store, and a success/failure response is passed to the user.

### Public UOE Staying Public

1. The Master Element (mE) is updated,
   a. If no other uOnty references the mE, then the mE is just updated
   b. If other uOntys do reference the mE, then a new mE′ is created with the E′ value, and this element has the same preceding links as the mE
2. The UOE is updated in the Onty Store and a success/failure response is passed to the user.

### Public UOE Becoming Private

1. The Master Element (mE) is updated—
   a. If no other the uOntys reference the mE, then it is deleted,
   b. If other uOntys do reference the mE, then nothing is done to the mE
2. The UOE is updated in the Onty Store and a success/failure response is passed to the user.

### Sd Move Onty Element

Moving a UOE involves changing one of the prior or subsequent links, only one may be changed by a user at a time.

### Description

1. A web page is displayed to a user on their web browser, proving a GUI for enabling the user to move a UOE from their uOnty.
2. The user selects a UOE in their uOnty and selects the move icon.
3. If the UOE is public then
   a. If the Master Element (mE) is only in use by this uOnty,
      i. The mE has it's relationships updated to match the move
   b. If the mE is in use by other uOntys,
      i. Add new links to match links provided for move
   c. If the result of the move leaves an orphaned graph (see FIG. 9), then they are deleted.
   d. Update UOE links to point to the ones supplied
   e. If the result of the move leaves an orphaned graph (as shown in FIG. 9) then that orphaned graph is deleted.

### Searching Sequence Diagrams

Searching within the system is shown via two diagrams, as the process diverges depending on the time taken for a search to complete. All searches begin with the website but if a search takes longer than 1000 ms it is sent to a specific application to do the search.

Sd Search from Website

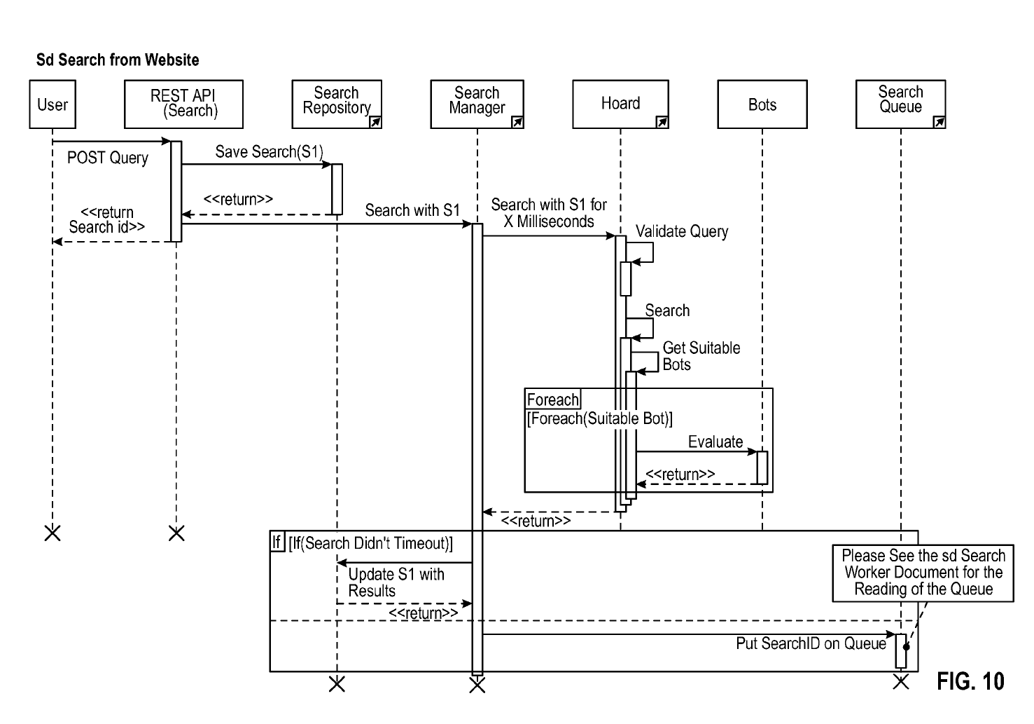

If the search completes within 1000 ms then the process is completed by flow of the diagram shown in FIG. 10, if it takes longer than 1000 ms the search is passed to the search worker.

### Description

The process is asynchronous.
1. A web page is displayed to a user on their web browser, proving a GUI for enabling the user to create a Search Onty (sOnty) from their uOnty.
2. The sOnty is POSTed to the Search API, an ID is generated for the sOnty and is saved to the Search Database (via the Search Repository).
3. The ID is returned to the GUI, allowing the GUI to poll for results.
4. Meanwhile—the sOnty is sent to a SearchManager, which sends the sOnty to the Hoard.
5. The hoard will validate the query (make sure it's made correctly—for example—it's a continuous chain of elements), and then get Bots that are suitable to service the query. Bots are either selected by the user, or all bots are used. If a bot is unable to handle to query (for example, a location bot can't deal with a sOnty with no location data) it will not be used.
6. Once the bots are found, they evaluate the sOnty (in parallel) against the Onty Element data store.
7. If the results are return in less than the configured timeout, then the Search database is updated with the results and the process ends.
8. Else the searches are terminated and the sOnty ID is put onto a Search Queue for the search worker to evaluate.

### Sd Search Long

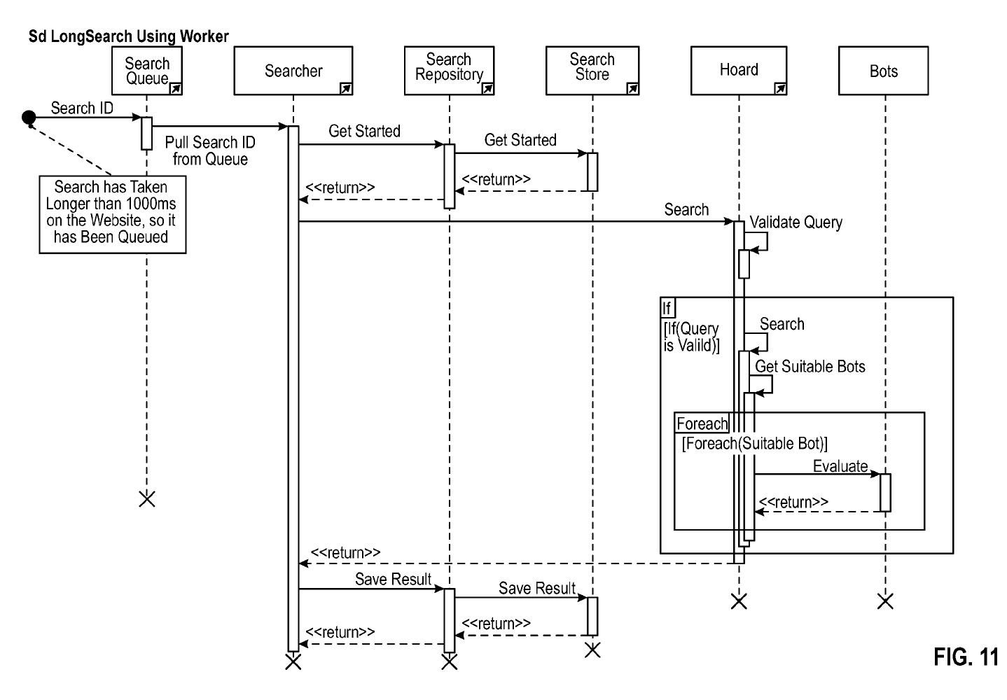

This process as shown in FIG. 11 is begun when a search takes longer than a configurable timeout (defaulted to 1000 ms).

### Description

1. A sOnty ID is put onto the Search Queue at the end of the website search process.
2. The Searcher reads the ID and retrieves the query from the Search Store
3. The Searcher sends the sOnty to the Hoard
4. The Hoard validates the query, and then gets suitable bots to run the sOnty against.
5. Each of the suitable bots evaluates the query and returns to the Hoard on completion.
6. The Hoard returns its results to the Searcher which then saves the results for retrieval at a later time.

### cmp Bot Hoard

The bot hoard contains and manages the various Bots in the system. It's hosted in the website itself, and in the search worker.

### Components

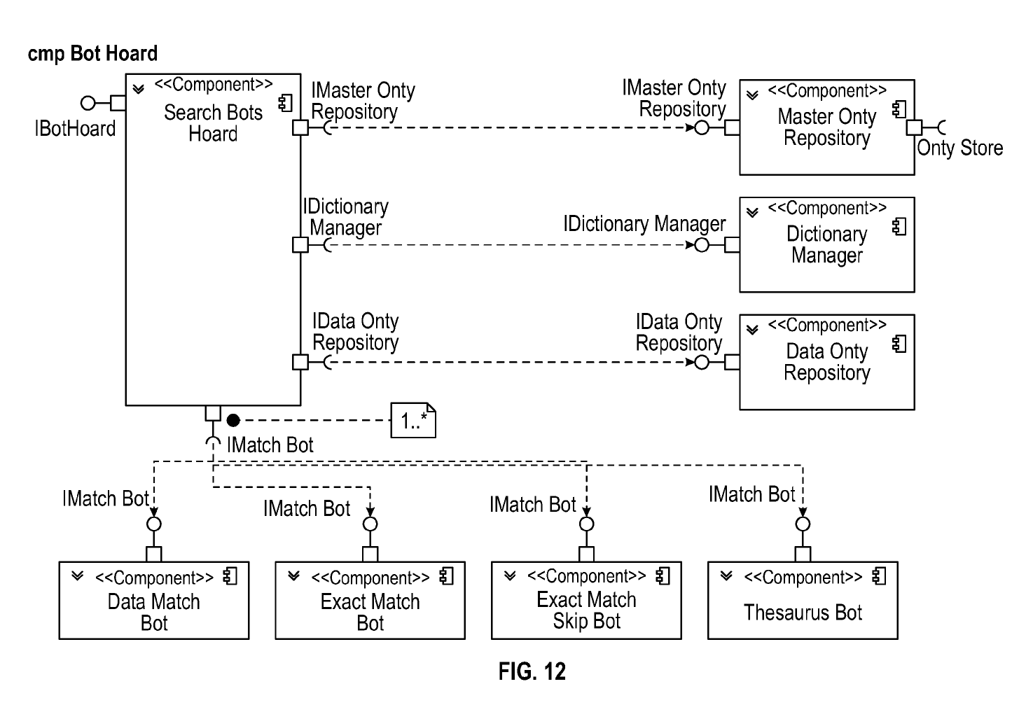

The components shown in FIG. 12 are described below.

### MatchBots

These are the actual bots, the hoard can contain any number of bots, as long as each bot implements the IMatchBot interface. The individual bots are described in greater detail later in this document.

### DictionaryManager

Handles interaction between any components (e.g. bots) and the Dictionaries.

### MasterOntyRepository

Manages all access to the Onty Store relating to the Master Onty Elements.

### DataOntyRepository

Manages all access to the Onty Store relating to the Data Onty Elements.

### Cmp Search Service

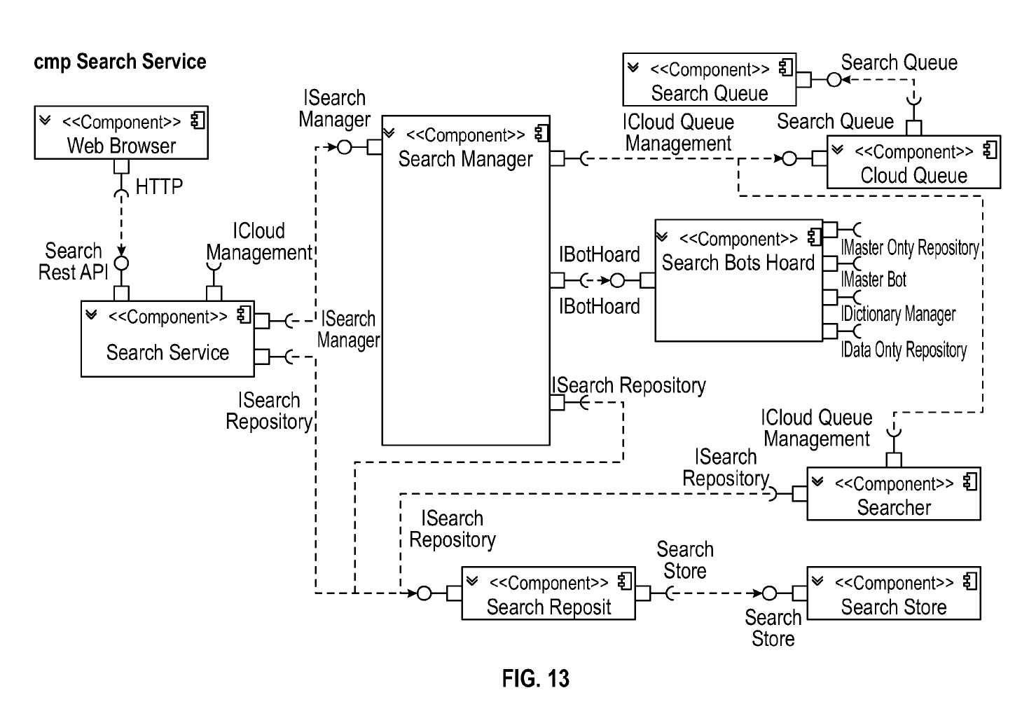

The cmp Search Service diagram in FIG. 13 displays the internal components of the Search Service, and how those elements link together.

### Diagram

### SearchService

The public facing REST service to allow a user to search. The website hosts this API to interact with the system when attempting search related actions (such as executing a search and retrieving results).

### SearchManager

The search manager initially deals with the searches by a user. It will attempt to match, but should the search hit a timeout limit it will cancel the search and pass it to the Search Queue (via the CloudQueueManager) to be read by the Searcher.

### Search Bots Hoard

The hoard is the store of the Bots. It has a collection of Bots and each search is run past each bot (unless specified by a user). Each bot will firstly say whether it can parse the query, and if so will attempt a match.

### SearchRepository

The search repository manages all access to the Search Store, any request to add, update, delete from the store is done via the Search Repository.

### CloudQueueManager

The Cloud Queue Manager manages all access to the Search Queue, any attempt to read from or write to the queue is done via the CloudQueueManager.

### Searcher

The searcher runs in a separate process and is used for executing long running searches (searches which have hit the timeout limit for the search manager)

### Search Queue

A queue to put long running searches on to. The SearchManager will put searches onto this queue if they take longer than a set timeout time. The Searcher will read off the queue and run the search independently.

### Search Repository

The search repository manages all access to the Search Store.

### Search Store

A database to store the queries made by users and the results. A search is stored into the database as soon as it is executed (without results), when results are found they are attached to the search in the database for retrieval later.

### Cmp Example Match Box Bot and Ad Example Match Bot

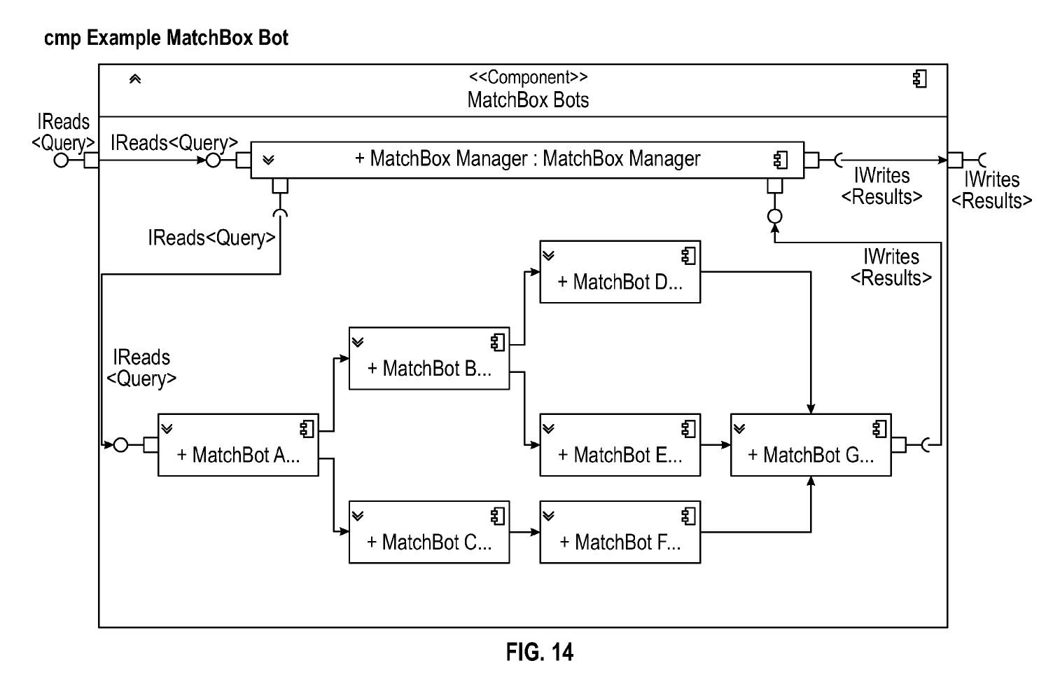

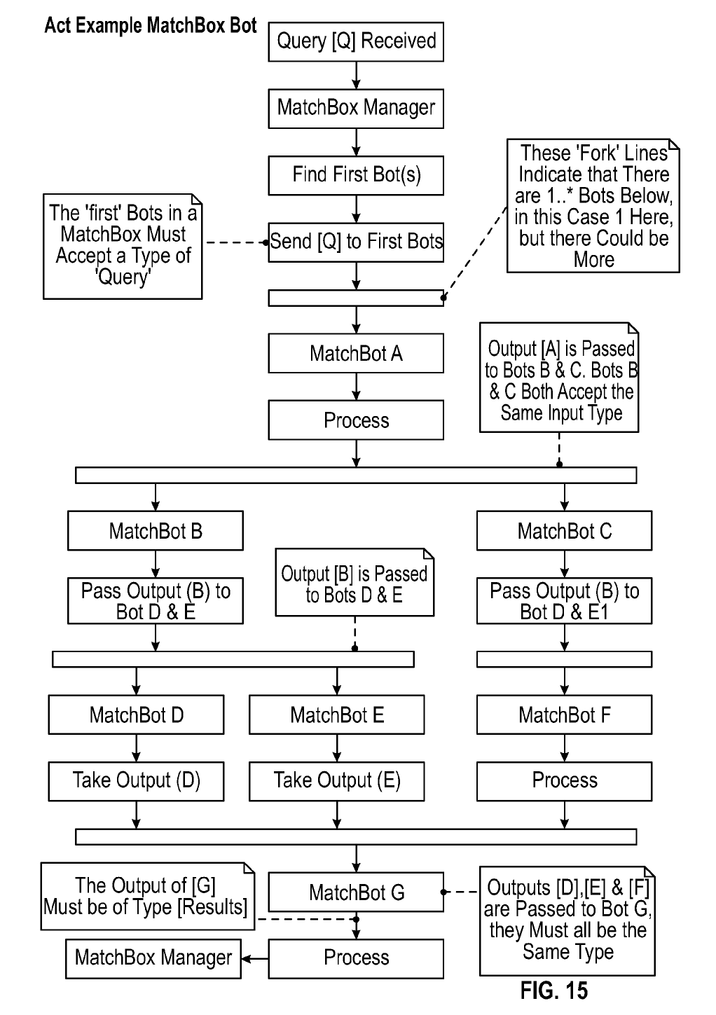

FIGS. 14 and 15 represent the flow through an example Match Box Bot (MBB).

The example MBB demonstrates an abstract bot design where one MBB hosts many (in this case seven) other bots.

### Component Wise—MatchBot A-G are Exemplary Only.

### Description

1. The MBB receives a Query and passes it to the first bot(s) in its internal collection (MatchBot A).
2. MatchBot A finishes its processing and provides an output suitable for MatchBots B and C to process.
3. MatchBots B & C process the input provided by MatchBot A, MatchBot B provides a suitable output for MatchBots D & E, and MatchBot C provides a suitable output for MatchBot F. MatchBots B & C do not need to output the same type.
4. MatchBot G waits for MatchBots D, E & F to complete their processing before starting its own processing. MatchBots D, E & F must provide the same output type for MatchBot G to handle.
5. MatchBot G finishes its processing and outputs a Results instance which is passed to the Match Box Manager—which passes out to the Match Bot Hoard.

### Inferers

Inferers are components of the system that infer onty elements based on a user's Onty. Two such inferer type are Additive Inferers and Complementary Inferers.

### Additive Inferers

Additive Inferers add elements to a user's Onty. Generally these work when a user enters a new value for their Onty and that value is parsed to see if any inferences can be gleamed from it. As an example, a user adds an element ‘Born’ with a Date Data Onty Element of ‘1980-01-14’, an additive inferer might add an ‘Age’ element with a Dynamic Measurement Data Onty Element with a Value of ‘35’ and Units of ‘Years’

### Complementary Inferer

A Complementary Inferer (CI) infers elements but doesn't add to the user's Onty.

Inferences are driven by the content of a uOnty, and will look for specific patterns to be able to perform inference, the initial adding/removal of an element merely begins the search for inference possibilities, generally a single element will not be enough to infer with.

Complementary inferers wouldn't typically be run whenever a user adds any element but whenever a keyword is added to (or deleted from) the uOnty. Each inferer would define a list of keywords it is interested in, whenever an action is committed that affects an element, the inferers are asked if it's something they're interested in or not.

If an inferer is interested it would attempt to perform inference. It's quite possible (likely even) that the inferer won't be able to do an inference initially, as it will require more information.

### Adding and Removing

A CI has a more complicated role than that of an Additive Inferer as its inferences are generally made from more complex patterns involving multiple elements.

### Adding

If a CI is adding then location needs to be well thought out, and careful checks need to be made to ensure no duplicate information is added. The addition of an element by a user that was previously inferred (so, an inferer has added ‘Female’ and the user subsequently adds ‘Female’ as well) should upgrade the inferred element to a fully-fledged uOnty element.

### Removing

A CI needs to remember what it's added to a uOnty, and remove any invalid inferences as and when a user removes/renames an element. It should treat each change as if it is the first time it has seen the uOnty—not base its decisions on prior knowledge of previous uOnty states. Importantly it should only remove inferred elements that haven't been upgraded.

### Implementation

There are a few implementation options, depending on performance of the inferers and how up-to-date inferences are required to be.

### Implementation 1

To save excessive workload, the inferers will store their relative success/fail scores against the user. The format of the information would contain the following fields:

| Name | Type | Description |
|---|---|---|
| InfererName | String | The name of the inferer. |
| DateRun | DateTime | The date and time the inferer ran against |
| | | the uOnty. |
| InfererVersion | String | The version of the inferer. |
| FoundInference | Boolean | Whether or not an inference was found. |

### Implementation 2

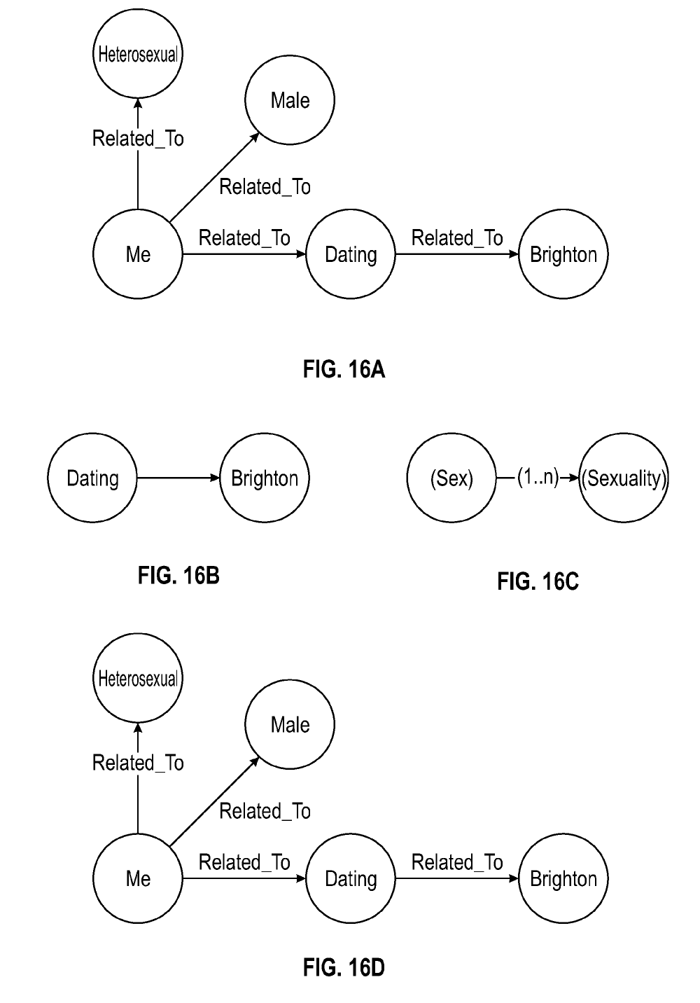

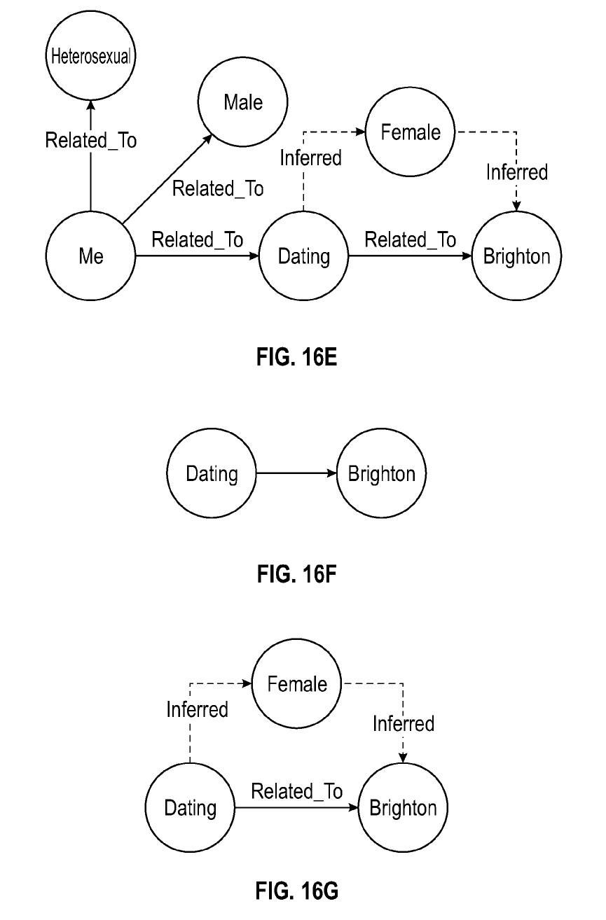

One option is to store a secret inferred set of Onty elements (not visible to the user), but allowing searches to incorporate the hidden elements. In the following example, we'll be discussing a ‘sexuality’ inferer (SexInf), which makes inferences about connected uOnty elements based on information provided by a user, so the user starts with the uOnty shown in FIG. 16a.

At present, searching for the sOnty in FIG. 16b.

Would return a lot of results, some of which would be undesirable—the user doesn't want to find Females looking for Males, or Males looking for Males, or indeed Females looking for Females. All of which are potential matches. The SexInf reads the users uOnty and is looking for something that matches the pattern shown in FIG. 16c.

Where [SEX] is a keyword like ‘Male’, Man′, ‘Woman’, ‘Female’ etc and [SEXUALITY] is something like ‘Heterosexual’, ‘Straight’, ‘Gay’, ‘Homosexual’, ‘Lesbian’ etc. With 1 . . . n connections between. In practical terms the pattern would need to be more complex, this is just an example.

In the example case, this matches with the highlighted values shown in FIG. 16d.

As it's matched with the uOnty, a secret inferred set of elements are added as shown in FIG. 16e.

The user doesn't see the inferred elements but searches could take it into account (not all bots would use/know about the inferred elements). So if the user now searches for the sOnty shown in FIG. 16f.

For some bots, that's all they'll see, but other bots will see the inferred elements as shown in FIG. 16g.

### Implementation 3

This takes the first and second implementation methods and does both of them. This is the most likely scenario as it provides the best performance.

### Examples

Aside from the dating/sexuality example, others would include inferences about things like the meaning of the word ‘Summer’—for example in the Northern Hemisphere summer is (roughly) June to September, but in the Southern Hemisphere it's from December to March.

Another example (again revolving around hemisphere difference) are Star Signs (astrological), which differ between northern and southern hemispheres.

### Sequence Diagram

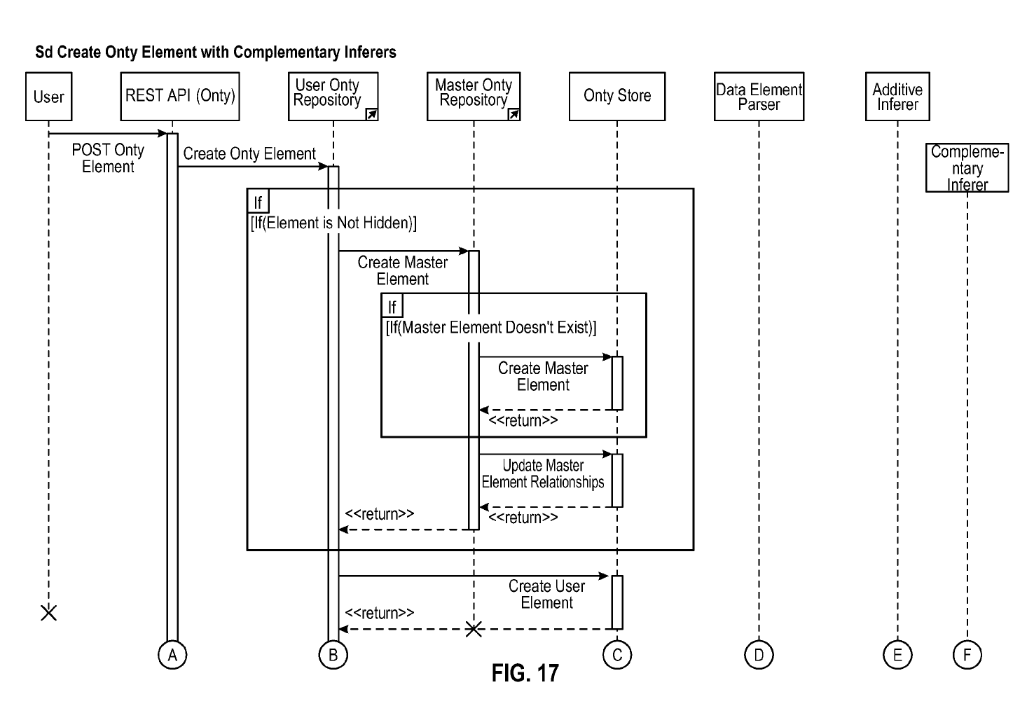

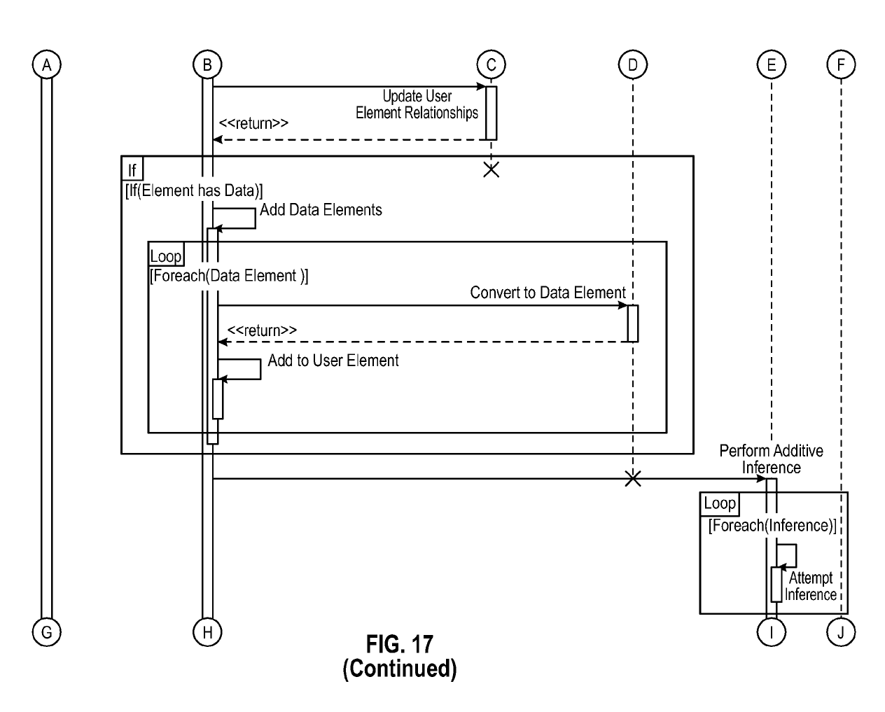

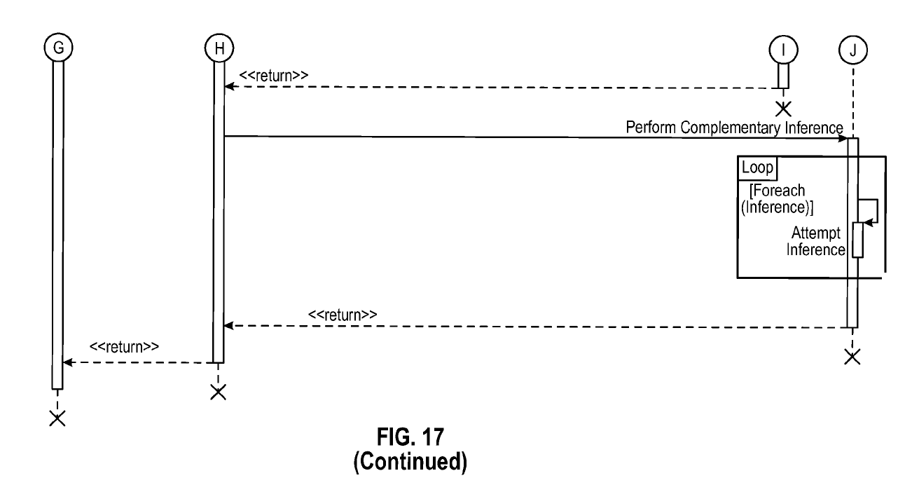

The diagram illustrating the complementary inferrer as shown in FIG. 17 is the same as the Create Onty Element diagram, with the only addition being the addition of a Perform Complementary Inference loop after the ‘Perform Additive Inference’ loop.

### System User Interface

An exemplary user interface provided by the system will now be described:

The UI consists of a main edit screen showing a localised, single level view of the user Onty. The single level view consists of a main root node, surrounded by a number (n) of child nodes. The number and nature of the child nodes can be altered under user settings.

The nature of the connections between root nodes and child nodes, is determined by the LinkedTo and LinkedFrom data supplied as part of the Onty node object.

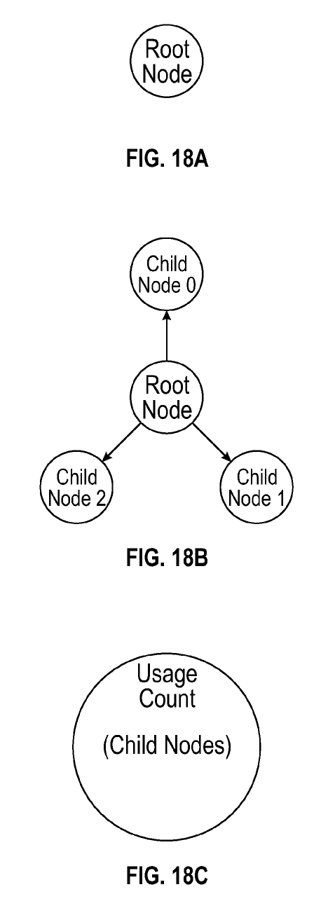

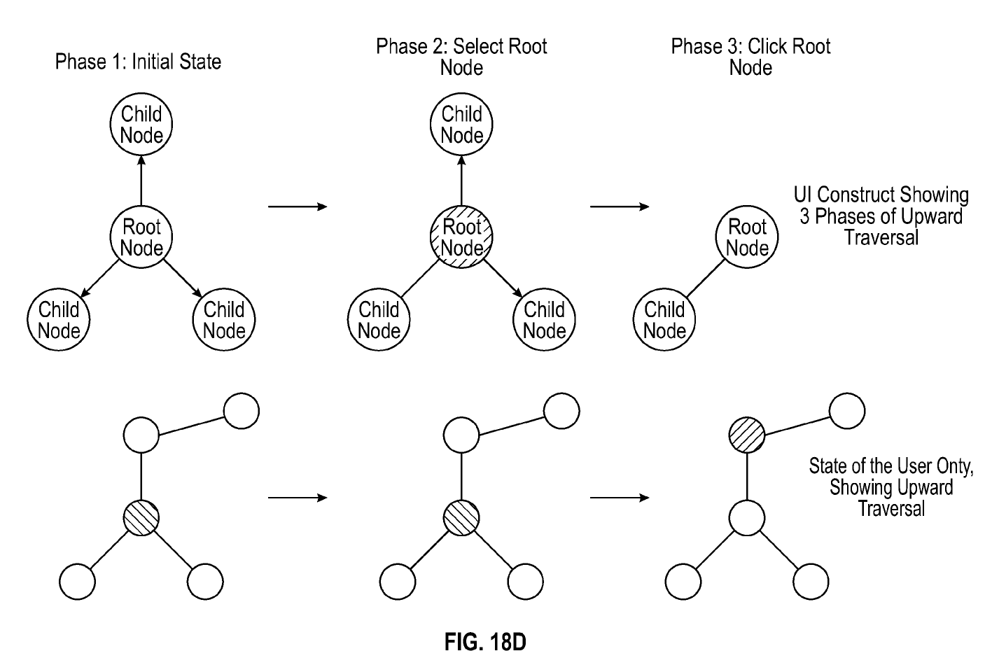

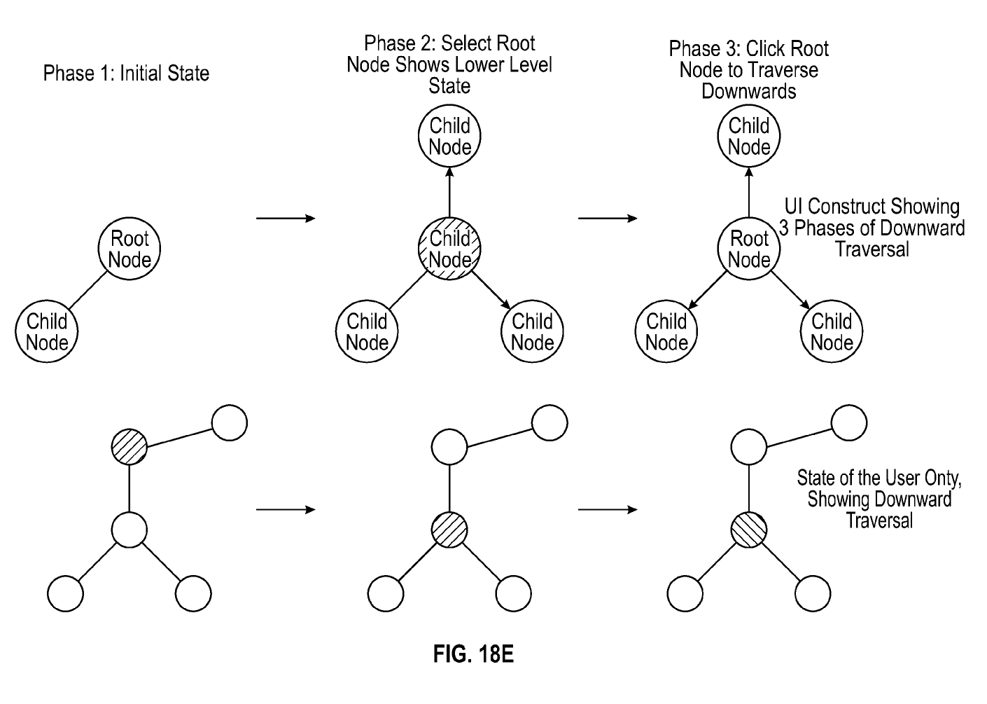

The fundamental (lowest node count) user Onty structure is one formed of a single (root) node. This node is given the value of ‘Me’, with an associated unique elementId, on the creation of a new user. The fundamental UI construct is therefore as shown in FIG. 18a.

An example of the node (root/child) system where the number of child nodes (n)>0 is therefore as shown in FIG. 18b.

The user is presented with the following navigation UI constructs which are discussed in detail below:
1. Navigation/traversal down the user Onty structure
2. Navigation/traversal up the user Onty structure
3. Insertion of net new nodes to root nodes
4. Insertion of net new nodes to child nodes
5. Insertion of master Onty suggestions to root nodes
6. Insertion of master Onty suggestions to child nodes
7. Update of nodes created from master Onty suggestions to accommodate net new data elements
8. Update of node object information, including data elements
9. Deletion of a node with a cascade of subsequent child nodes
10. Deletion of a node with a reformation of the parent to child relationships (in effect a ‘knock-out’ deletion)
11. Reformation (moving) of links between nodes in the user Onty.

### Node Design

Each node within the UI construct has the possibility of displaying within itself a number of additional pieces of information. Currently normal (non-master nodes), display the number of child nodes from the selected node at their centre. Master nodes display an additional piece of information, which is the usage count for the master node, within the master Onty. This can be seen in FIG. 18c.

Each node is connected to other nodes by a single line. This denotes the LinkedTo relationship as defined in the user Onty Object Definition.

### Navigation

Traversal of the user Onty is bi-directional (up and down). The main navigational concept can be seen as:
1. Selection of a root node, as defined by the node presented in the centre of the main UI construct, and subsequent mouse down event, signifies traversal up the user Onty structure.
2. Selection of a child node, as defined by nodes connected to the root node, and subsequent mouse down event, signifies traversal down the user Onty structure.

In each UI construct the UI performs an animation to bring the selected node to the centre of the UI, thus highlighting it. Additional rollover states are also applied to the root nodes (centre nodes), in order to signify that an event has been triggered.

### Selection of the Root Node

If there are no parent nodes to the current root node, which occurs when the root node is equal to the user Onty Me node (top level node), then only the edit dialog is displayed, no upward traversal is allowed.

If there are parent nodes from the current root node, the user is presented with the following UI construct. Consecutive actions are then displayed in the flow shown in FIG. 18d.

The user can decide in stage two to select the root node and traverse upwards, or click on any part of the UI construct to cancel the action.

The root node of phase one and two becomes the child node of phase three.

### Selection of a Child Node

The selection of child nodes to the root, is used to display a view of the nodes in the next level, and subsequently the ability to traverse down to that level. It is the reverse route to the selection of the root node. Consecutive actions are displayed in the flow shown in FIG. 18e.

In the case of downward traversal through the user Onty, the middle step displays a view of the next level down, so the user can make a decision on whether to traverse from the selected node. If they decide not to they can click on any part of the UI construct to cancel the action.

The child node of phase one and two becomes the root node of phase three.

### User Onty Manipulation

### Insertion

Insertion of new nodes into the user Onty has two main modes. These are:
The insertion of new new nodes into the user Onty
The insertion of master Onty suggestions into the user Onty.

Both insertion types are triggered by rolling over the requisite node. This can be a root node (centre node in the UI), or a child node (on the first outer circle). The difference in insertion between the root and child nodes is only apparent in the redrawing of the UI post insertion.

If a new node is inserted on a root node, post insertion the UI redraws using the current root node as the starting point. This is because the insertion is related to the current root node.

If a new node is inserted on child node, post insertion the UI redraws using the child node as the starting point. This is because the UI requires to view the child node as the new root node, in order to view the newly inserted node.

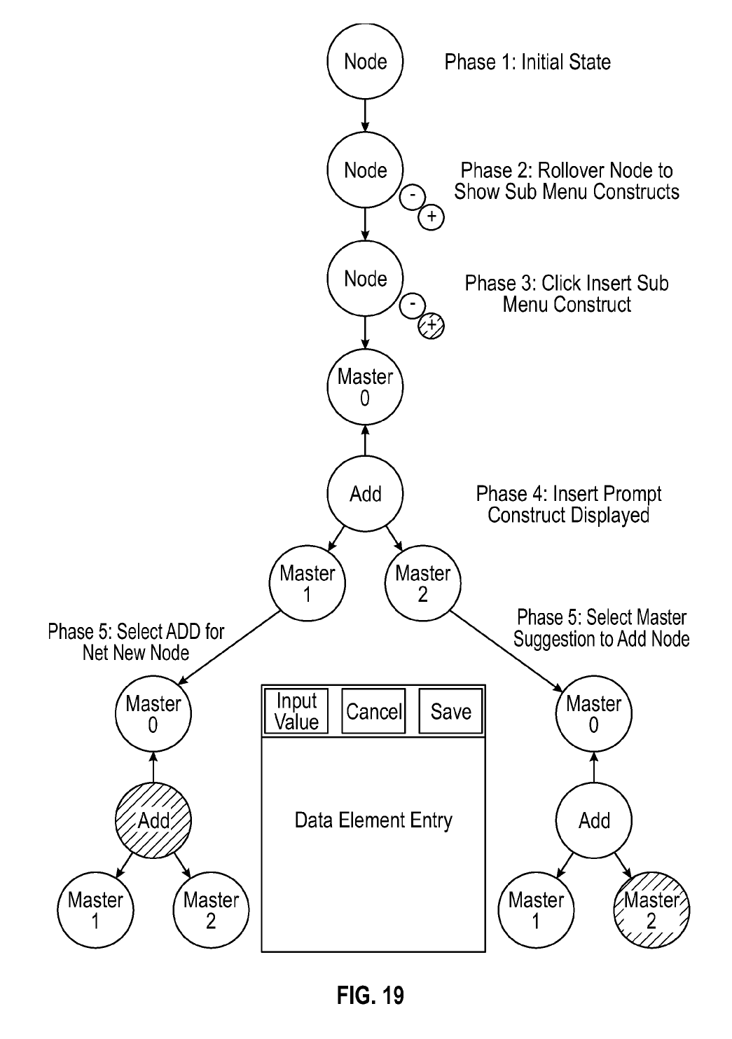

The flow in FIG. 19, shows the first four phases of node insertion as the same, this is because up to an including the section of the insert sub menu construct (+), the operations carried out by the user are the same. On clicking the insert sub menu construct (+), the UI displays, if appropriate a new prompt, which at its centre has a node labelled ADD, and on the outer circle, a number of master Onty suggestions.

The number of master Onty suggestions is less than or equal to 10, giving the current highest ranking suggestions in terms of master Onty usage counts.

In choosing to add a net new node, or to add a master Onty suggestion, the user is presented with a modal dialog. This dialog (shown in the centre of the diagram below), is pre-populated with a value for the insertion of master node suggestions, and is empty for net new nodes.

### Update

Updates to nodes follow a similar pattern to inserts, and are triggered when any node is selected (see clicking on nodes in the navigation section).

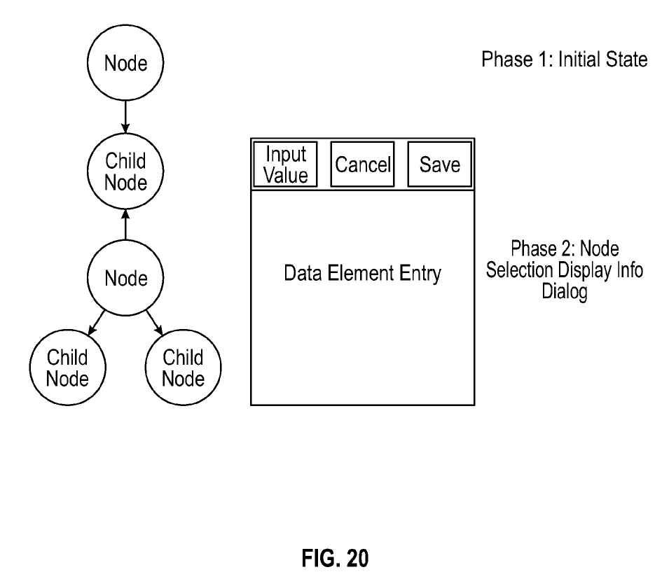

As this flow (as shown in FIG. 20) is related to the update of current nodes, both value information and data element information is populated on the selection of a node. This is in comparison to node insertion, where the value and data elements are blank, unless a master node suggestion is chosen, in which case the value is pre-populated.

Any changes to the node value or data elements, are saved on selecting save. The user can cancel the update action by choosing cancel.

### Delete

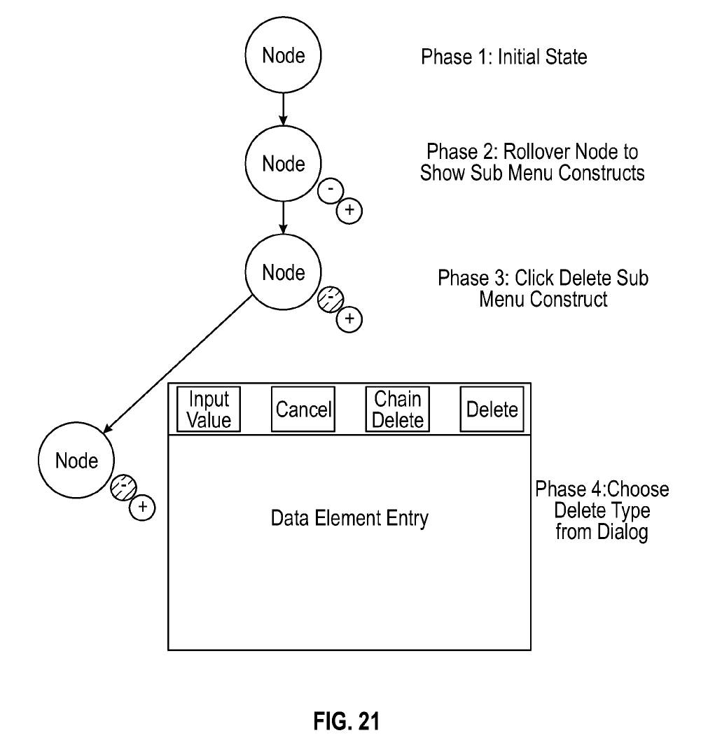

Deletion of user onty nodes again follows a similar pattern to insertion. The main difference being the choice of sub menu UI construct being the delete construct (−). Deletion is illustrated in FIG. 21.

On choosing the delete sub menu UI construct the user is presented with the delete modal dialog. The dialog displays the pre-populated information related to the chosen node.

There are two delete options, delete and chain delete.

The normal delete function will delete only the selected node. The system will then reform relationships between the parent node of the deleted node, and the child nodes of the deleted node, if they exist within the user Onty.

Deletion of nodes from the user Onty, does not delete the nodes from the master Onty structure.

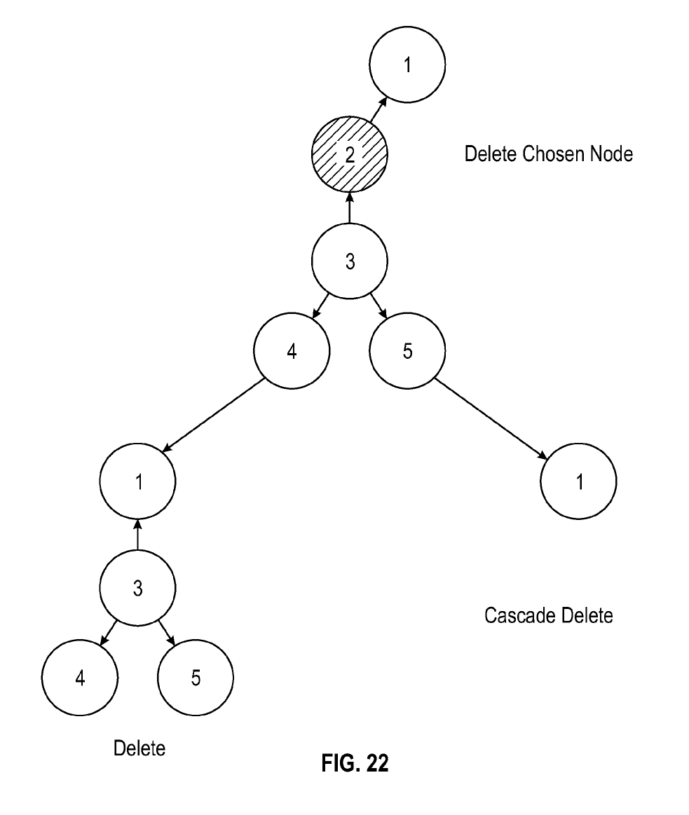

The chain delete, will delete the selected node, along with any child nodes of the selected node as shown in FIG. 22.

### Move Relationship

In addition to the function for insert, update and delete, it is possible to reform the relationships between nodes within the user Onty. It is to be seen as a moving of relationships, not as nodes.

Each node within the user and master Onty has two properties; LinkedFrom and LinkedTo. These define the relationships between nodes. On forming the move functionality, is it based on the reclassification of the LinkedTo and LinkedFrom properties.

The move function requires a new user interface construct to provide a means of seeing multiple levels of the user Onty all at once. This construct is the Story Map.

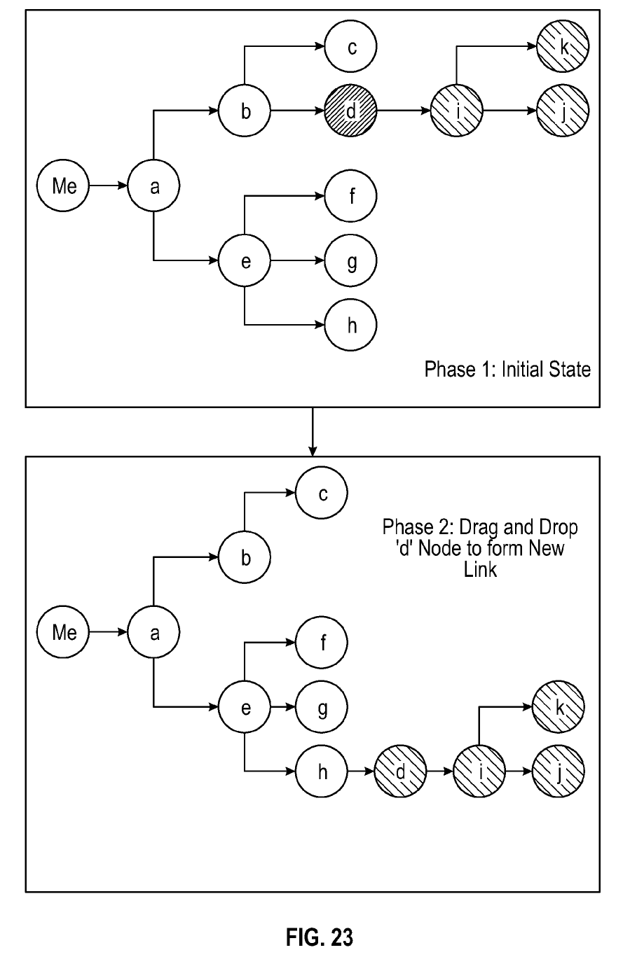

The story map interface as shown in FIG. 23, allows the user to view the user Onty as a connected tree. The nodes in the tree can be selected, and then using a drag and drop action, moved from one part of the user Onty to another.

On starting the drag operation, the relationship is broken between the chosen node, and its parent. If the drag operation is cancelled at this point, the UI construct will reform the original relationship, and no update will take place.

If the user starts the drag operation, and in so doing drags the selected node to within a few pixels of a different parent node, a new relationship link will appear as a preview. On dropping the node, when the new link is active, the relationship will be reformed and the user Onty updated. This is an automated process, with no user confirmation dialogs.

If the drag drop operation completes with the formation of a new relationship, the main UI construct will redraw using the current root node as the starting point.

### Data Element UI Constructs

There are currently four UI constructs for the addition of data elements to Onty nodes. These UI constructs cover:
1. Date/calendar entry: A general calendar UI is displayed, with the ability to select dates.
2. Time entry: A time entry UI is displayed, allowing the user to select hours and minutes to define a chosen time (hh:mm)
3. Location entry: OpenLayers API is used to display, select and insert Long, Lat coordinates as data elements
4. Measurement entry: A simple input field is displayed, to allow the user to input values, and a dropdown is displayed for the choice of units. The dropdown can be added to in order to provide unit alternatives.

### Date

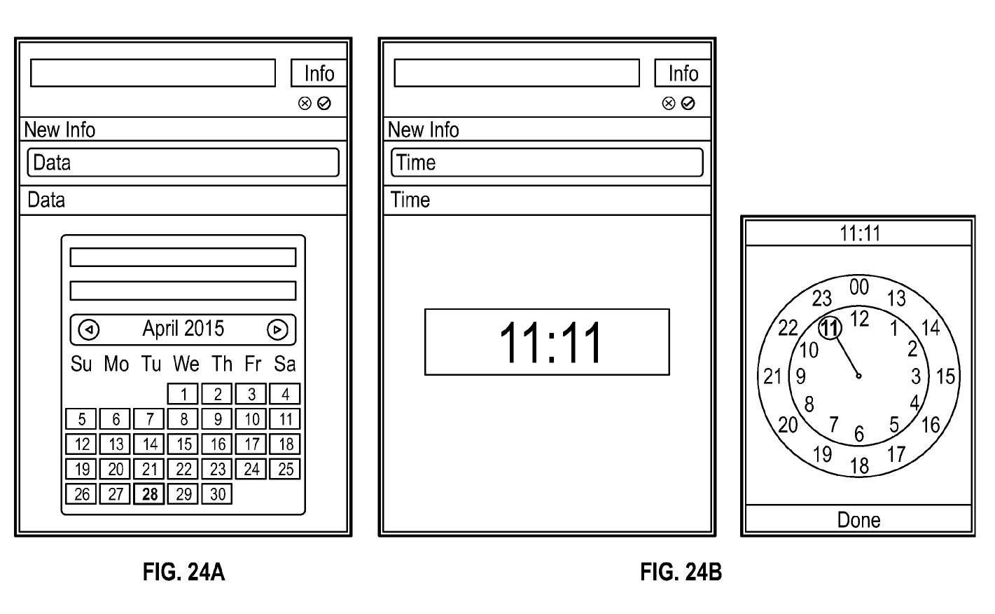

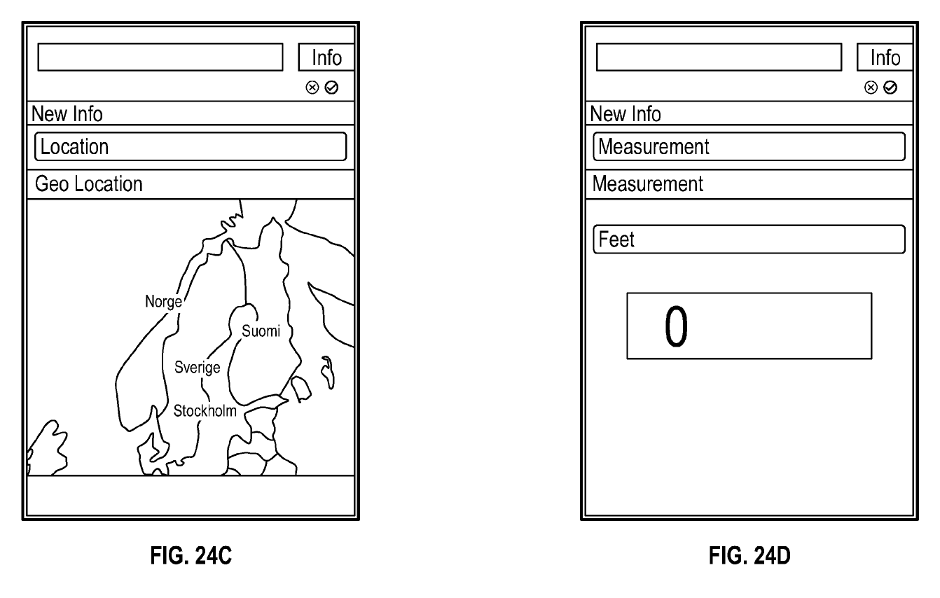

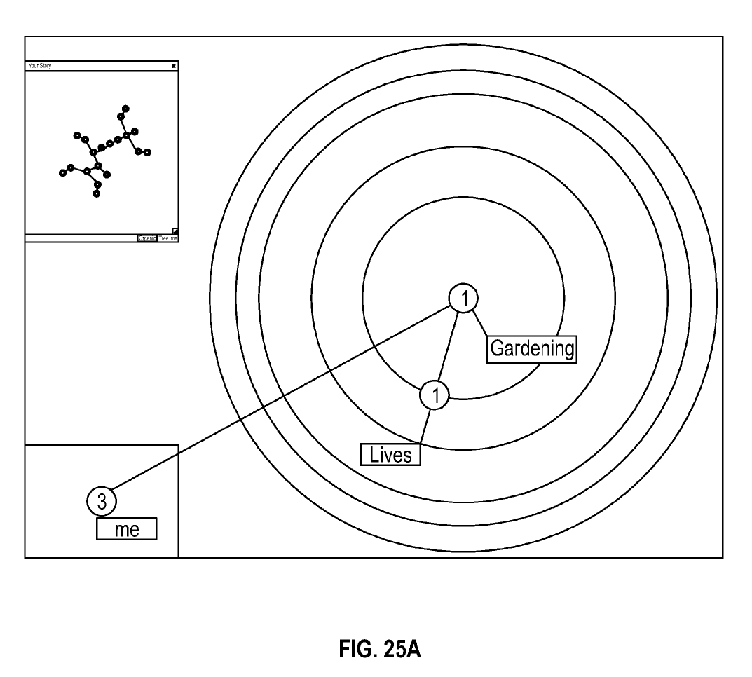

The user can select dates within the UI shown in FIG. 24a by clicking on the calendar, the month and year can be altered using the <and > buttons. More date search/choice function will be added over time.

### Time

The user can click on the time input field (11:11 by default) within the UI shown in FIG. 24b, which opens up the hour and minute selector dialog.

### Location

The user can pan and zoom the map within the UI shown in FIG. 24c. On clicking a lat/long coordinate will be set and displayed as a pin on the map.

### Measurement

The user can select a unit type (feet, inches, kilogrammes etc.), and then enter a numerical value in the input box within the UI shown in FIG. 24d. The system will attempt to store the data as entered, as well as duplicate entry for SI conversions. This allows all subsequent searches to be carried out on a SI unit basis.

### Exemplary Screenshots of the User Interface

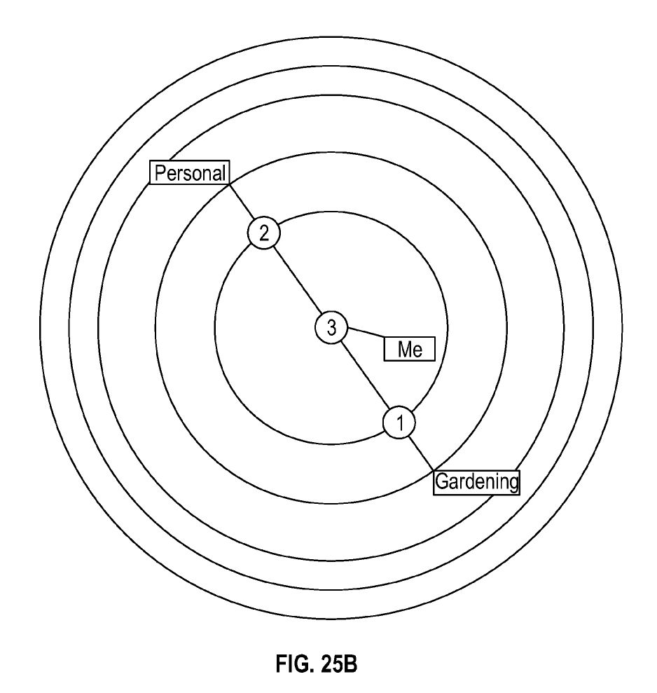

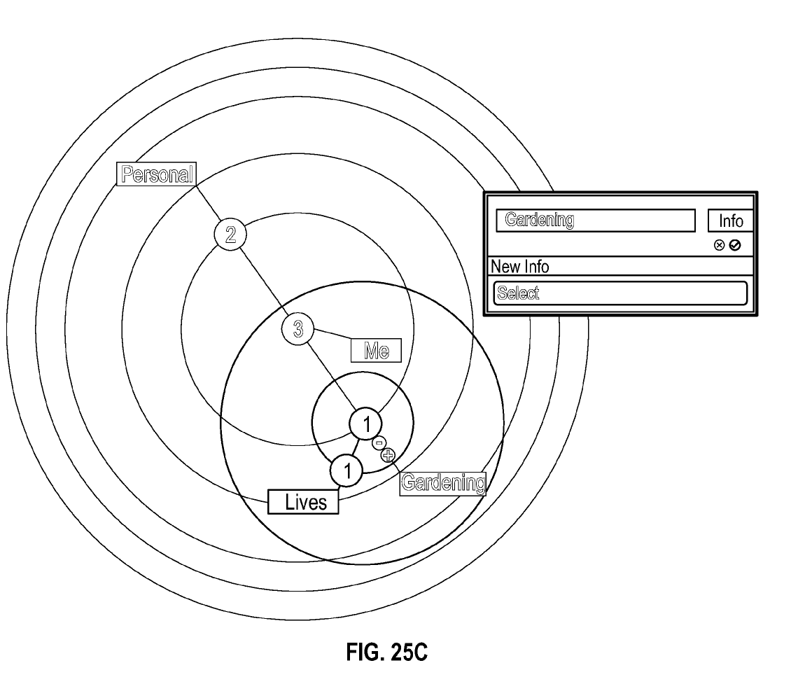

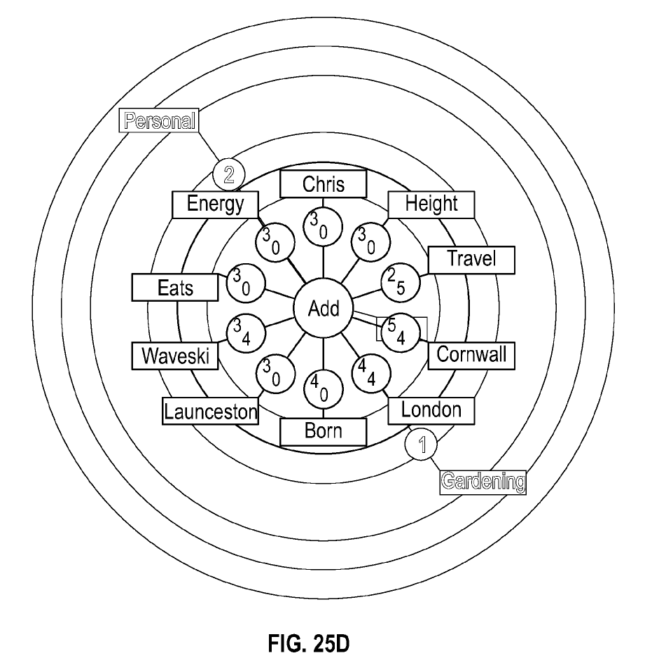

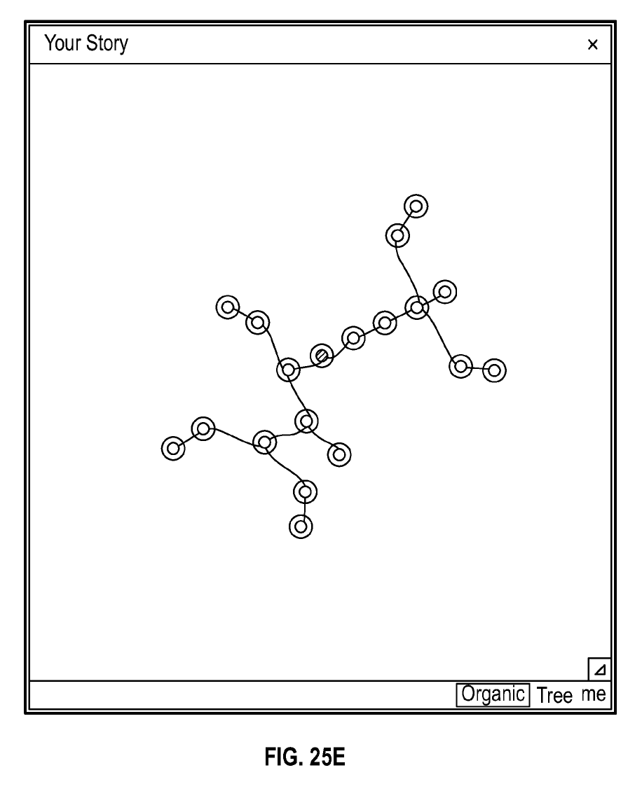

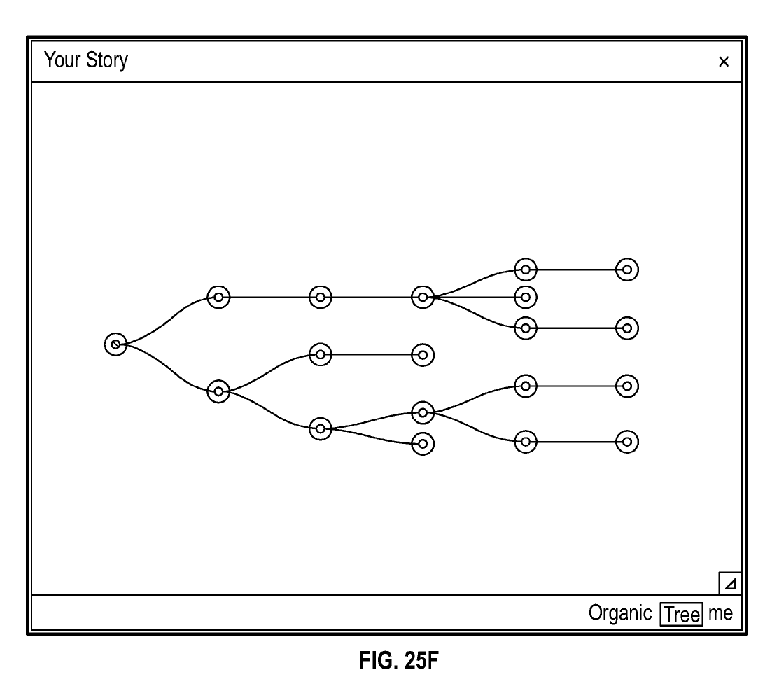

Initial layout is shown in FIG. 25a.

### Main Elements:

Main root node (selected in red)
Parent view (white section in bottom left corner), shows the parent node of the current root node
Child nodes of the root node (shown as connected nodes to the main root node
Story map organic view

Node interface is shown in FIG. 25b.

### Main Elements:

Main root node, with two child nodes

Node selection (click on node) is shown in FIG. 25c.

### Main Elements:

Selected child node in centre
Child nodes of the next onty level
Information modal dialog for node updates

Insertion UI is shown in FIG. 25d.

### Main Elements:

Master onty suggestions and net new node ADD construct
Master onty suggestions showing the number of child nodes, and usage counts within the master onty

### Story Map

Organic view for the Story Map is shown in FIG. 25e.

### Main Elements:

Current editable node (in red), with onty levels (up to twenty levels down)

Tree view for the Story Map is shown in FIG. 25f.

### Main Elements:

Currently editable node (in red), with onty levels (up to twenty levels down) in tree mode. This mode is used for the reformation of node to node relationships.

### Matching Engines

Further detail will now be provided above the different matching engines or Onty Bots that can be used to search for matches across the User Ontys.

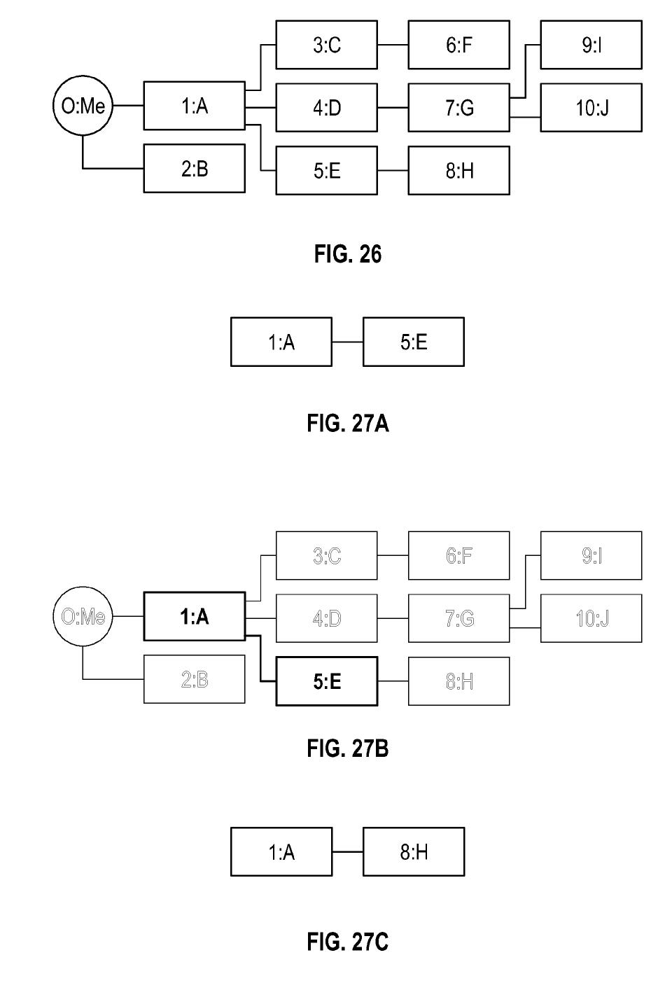

The following Onty Bot will be explained with references to FIG. 26 which shows an exemplary result Onty (rOnty).

### Exact Bot

The Exact Bot (EB) is the simplest bot in the system. It searches for the same Onty elements in another users Onty (uOnty).

### Example 1—a Match

User searches for the elements shown in FIG. 27a.

This matches with the rOnty on the following elements shown in FIG. 27b.

### Example 2—No Match

User searches for the elements shown in FIG. 27c.

There are no elements that match in the rOnty.

### Exact Skip Bot

The Exact Skip Bot (ESB) runs in a similar fashion to the EB, but it has the ability to ‘skip’ or ‘jump’ over elements, making it more forgiving when searching.

Parameters

| Name | Rules | Default | Description |
|---|---|---|---|
| Steps | 1 ≤ steps ≤ 3 | 2 | The number of skips to allow |
| | | | for a match. |

### Example 1—Match

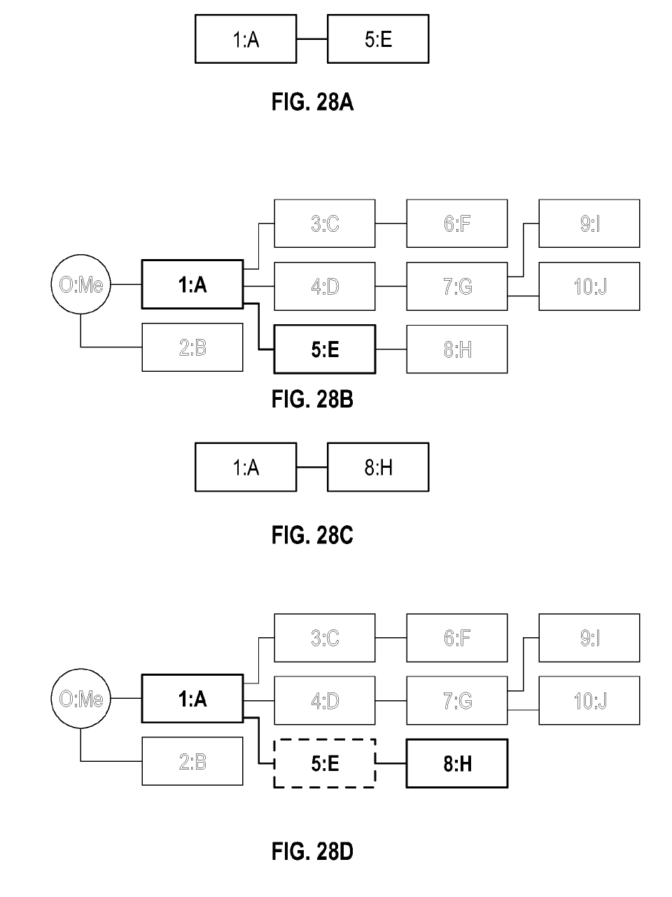

User searches for the elements shown in FIG. 28a.

This matches with the rOnty on the elements shown in FIG. 28b.

### Example 2—Matching with Skips

User searches for the elements shown in FIG. 28c.

This matches with the rOnty on the elements shown in FIG. 28d.

### Thesaurus Bot

The thesaurus bot builds on the ESB and adds the ability for a user to look for synonyms as opposed to just the words selected. The synonyms are brought in from a dictionary/thesaurus.

Parameters

| Name | Rules | Default | Description |
|---|---|---|---|
| Steps | 1 ≤ steps ≤ 3 | 2 | The number of skips to allow |
| | | | for a match. |

### Example 1—Match with Words the Same

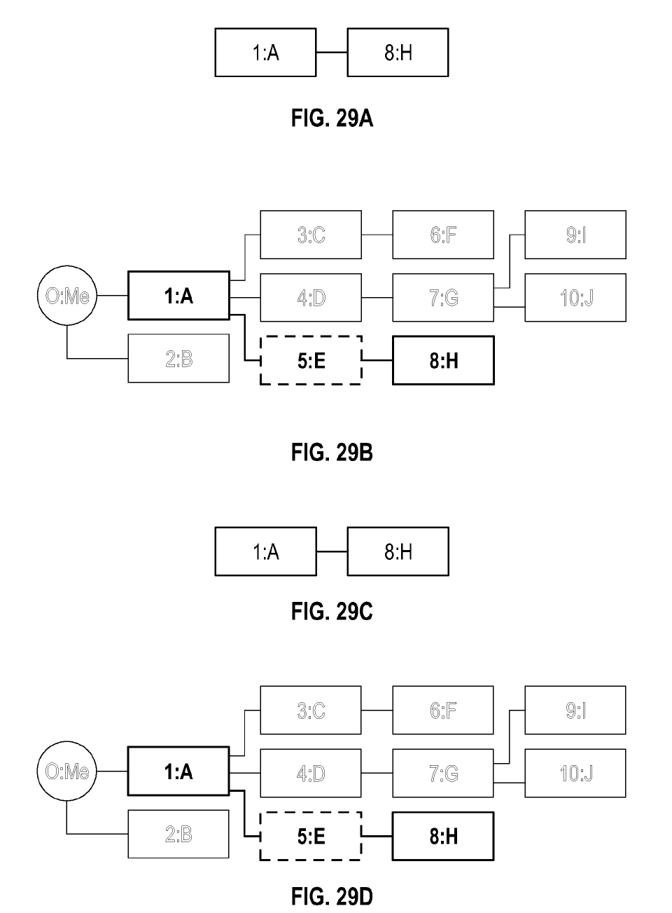

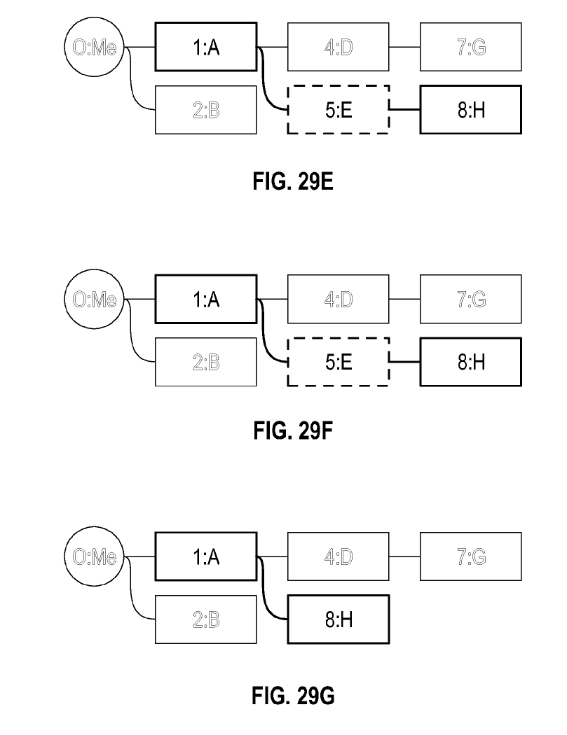

User searches for the elements shown in FIG. 29a.

This matches with the rOnty on the elements shown in FIG. 29b.

### Example 2—Match with Synonyms

In this example, A′ is a synonym of A and H′ is a synonym of H.

User searches for the elements shown in FIG. 29c.

This matches with the rOnty on the elements shown in FIG. 29d.

The bot has in this case looked up the synonyms (which may be limited to those synonyms which exist in the mONTY and the total set of hidden nodes) for A and H and then proceeded to search for matches (including steps as described in the ESB) for all possible combinations. So the rOntys shown in FIG. 29e (Only H is a synonym, A′ is the same as the query), 29f (Only A is a synonym, H′ is the same as the query), and 29g (No ‘steps’ required to match) would also have matched.

### Data Bot

The data bot is the most complicated bot at present, it will work in a similar way to the Thesaurus Bot, but works with the data elements attached to elements. This allows a searcher to vary the specificity of their query from something like the exact date, to 2 weeks either side of a given date (for example).

### Data Elements

There are 4 types of data elements in the system:

### Date

The date element is just a date, with no time information stored.

### Time

The time element is just a time, with no date information stored.

### Measurement

The measurement elements are for storing any SI (International System) units. The units are defined by the user (for example Centimetres, Centigrade, Stones) and stored in the base SI unit, so if someone stored −273.15° C. the underlying structure would store the actual value entered by the user and 0° K as well.

### Location

The location element is an element with Latitude and Longitude properties.

Parameters

| Name | Rules | Default | Description |
|---|---|---|---|
| Steps | 1 ≤ x ≤ 3 | 2 | The number of skips to allow for a |
| | | | match. |
| Diameter | 0.0 < x ≤ 180.0 | 1.0 | The diameter of the search around the |
| | | | location on the search element |
| DaysBefore | x > 0 | 0 | Number of days before to search for |
| DaysAfter | x > 0 | 0 | Number of days after to search for |
| WeeksBefore | x > 0 | 0 | Number of weeks before to search for |
| WeeksAfter | x > 0 | 0 | Number of weeks after to search for |
| MonthsBefore | x > 0 | 0 | Number of months before to search for |
| MonthsAfter | x > 0 | 0 | Number of months after to search for |
| YearsBefore | x > 0 | 0 | Number of years before to search for |
| YearsAfter | x > 0 | 0 | Number of years after to search for |
| LowerBoundValue | x > 0 | 0 | Sets the lower bound as an absolute |
| | | | value |
| UpperBoundValue | x > 0 | 0 | Sets the upper bound as an absolute |
| | | | value |
| LowerBoundPercent | x > 0 | 0 | Sets the lower bound as a percentage of |
| | | | the search element value |
| UpperBoundPercent | x > 0 | 0 | Sets the upper bound as a percentage of |
| | | | the search element value |
| HoursBefore | x > 0 | 0 | Number of hours after to search for |
| HoursAfter | x > 0 | 0 | Number of hours before to search for |
| MinutesBefore | x > 0 | 0 | Number of minutes after to search for |
| MinutesAfter | x > 0 | 0 | Number of minutes before to search for |
| SecondsBefore | x > 0 | 0 | Number of seconds before to search for |
| SecondsAfter | x > 0 | 0 | Number of seconds after to search for |

If any of the parameters are not supplied (which would be the normal case) then the defaults are used for any data elements. Parameters are only applied to data elements that make sense e.g. the Diameter parameter would not be applied to a Date data element.

### Examples

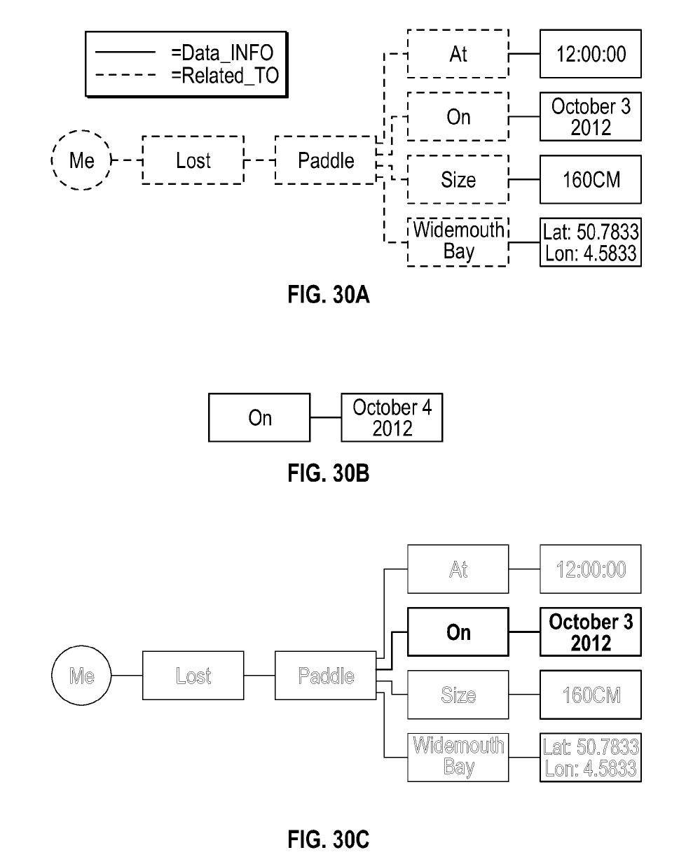

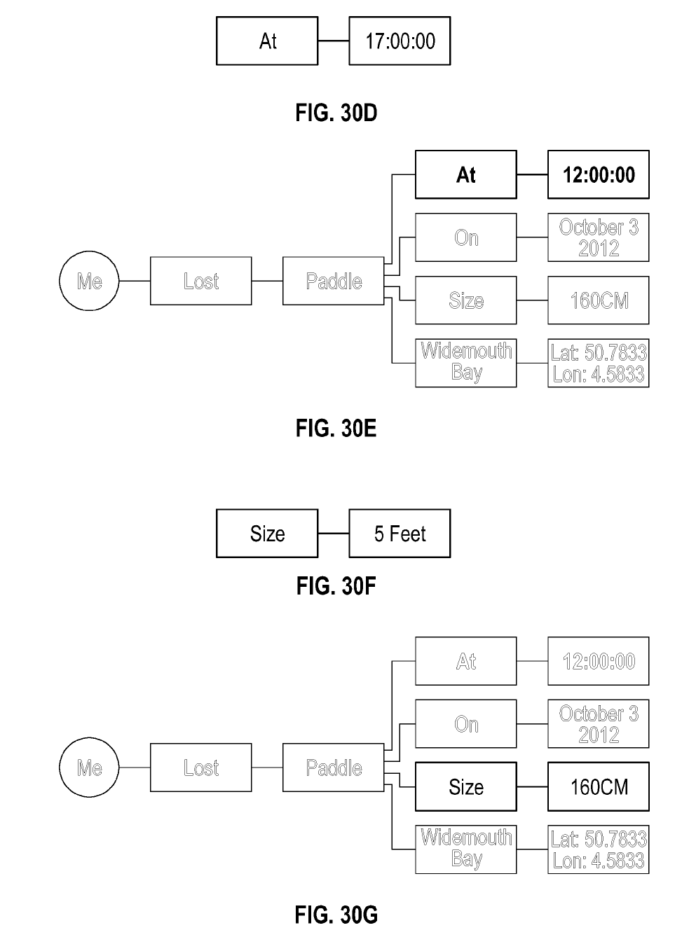

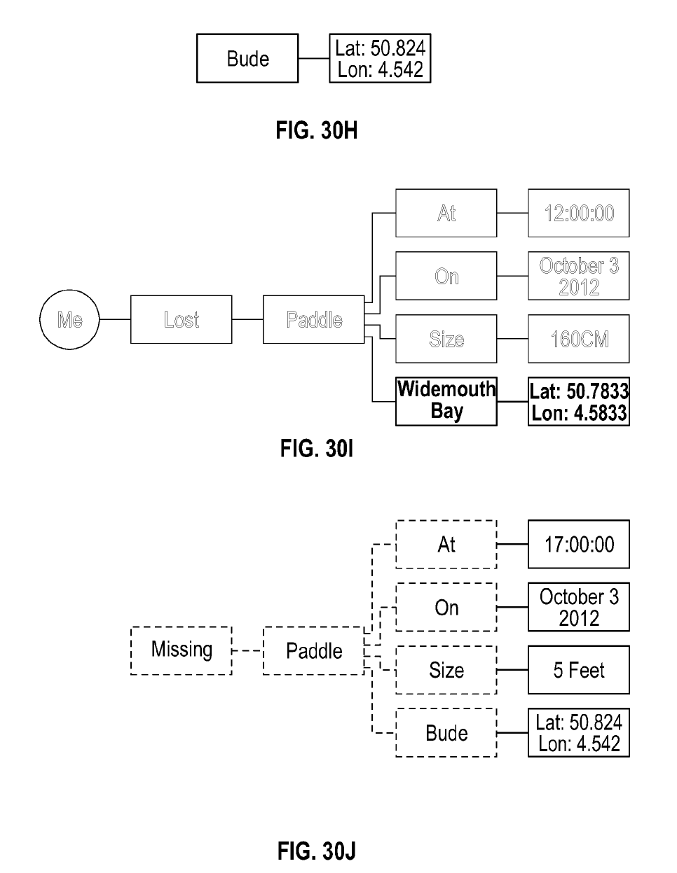

The examples for this bot use the rOnty shown in FIG. 30a.

The colours for the relationships stays the same throughout the examples.

In the examples, the searcher is the one who has found a paddle, and is looking to see if the person who lost it has put the fact that they have lost it into Onty.

### Example 1—Date Example

User searches for the elements shown in FIG. 30b.

With a ‘DaysBefore’ parameter of 2, this means Onty will look for dates from the 2^{nd} of Oct. 2012 to Oct. the 4^{th} 2012 (inclusive).

This matches on the rOnty as shown in FIG. 30c.

### Example 2—Time Example

User searches for the element shown in FIG. 30d.

With HoursBefore set to 17 and HoursAfter set to 7 (covering the full 24 hours), which matches the rOnty shown in FIG. 30e.

### Example 3—Measurement Example

This example shows the ability for the system to translate between SI units. The searcher queries using feet, but the rOnty is actually in Centimetres. In both cases the actual underlying data element is stored as the SI unit (in the case of length, this is Metres).

User searches for the elements shown in FIG. 30f.

With parameters of UpperBoundPercent and LowerBoundPercent of 10. This means that the user is searching for a range of 5 feet±10%—or in centimetres: 144 size 167.2, which matches the rOnty shown in FIG. 30g.

### Example 4—Location Example

In this example, the searcher doesn't know the exact beach they found the paddle, so they've added a local town nearby, and by setting the parameters to allow a diameter of 0.2 they encompass the rOnty value as well as shown in FIG. 30h.

This matches the rOnty shown in FIG. 30i.

### Example 5—Combining all

In a closer approximation to real life—a user would likely combine all the searches together, and so could perform a search shown in FIG. 30j.

Which with the parameters set as above would match to the rOnty. The user might initially make the query with different parameters—get no (or too many) results—and so tweak them, making them more/less specific as required.

Of extra note is the use of the Thesaurus toolset to match Lost and Missing in the first Element.

### LinguaBot

The LinguaBot (LB) allows matches to be found when the languages of the various Onty users don't match. For example, someone in Sweden might search for ‘kyckling’-‘Wyandotte’, and be matched with a chicken breeder in the UK by: ‘Chicken’-‘Breeds’-‘Wyandotte’.

Parameters

| Name | Rules | Default | Description |
|---|---|---|---|
| Steps | 1 ≤ x ≤ 3 | 2 | The number of skips to allow for a match. |
| LanguagesToIgnore | n/a | Empty | A list of languages to ignore, i.e. if a user |
| | | | doesn't want to match with a given language |
| | | | they can specify it here. |
| LanguagesToUse | n/a | Empty | A list of languages to compare with. If |
| | | | present this overrides the |
| | | | LanguagesToIgnore parameter. |

### Examples

A couple of examples to show the basic working of the LinguaBot.

### Example 1—Basic Translation

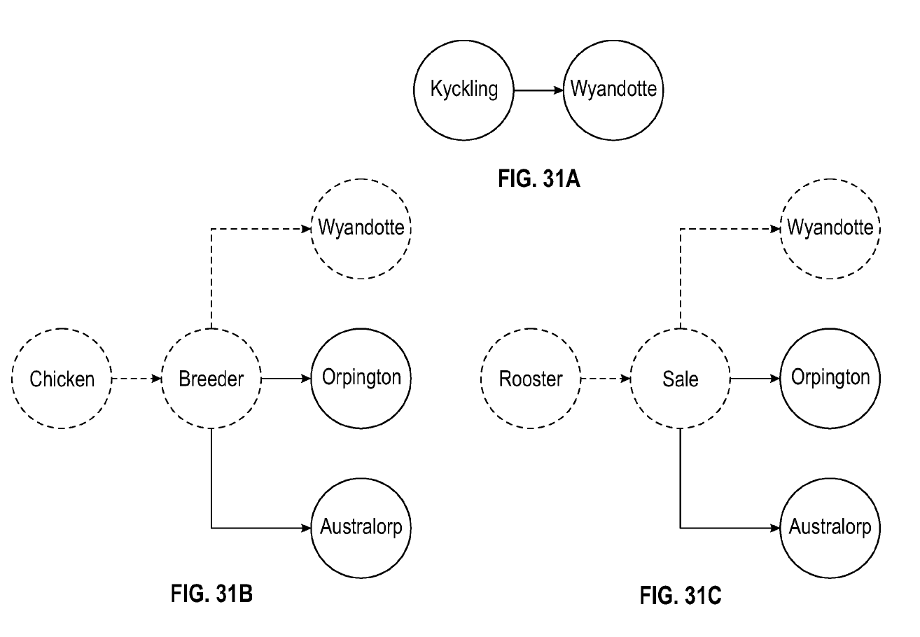

User 1 (Swedish) searches for (with a Steps value of 2) as shown in FIG. 31a.

The LinguaBot translates ‘Kyckling’ into ‘Chicken’ and there are no translations for Wyandotte, so matches with User 2, who has elements as shown in FIG. 31b.

The ‘Breeder’ element is ignored as the user has a steps parameter value of 2.

### Example 2—More Complex Match

User 1 searches for the same elements as above, but this time matches the rOnty shown in FIG. 31c.

As the bot works out that Kyckling (Swedish) is Chicken in English, and Rooster is a suitable match for it. The ‘Sale’ element is ignored as the searcher has a steps parameter of 2.

### Inference Bot

An inference bot performs searches using inferences generally acquired from the Complementary Inferers. Given a query, the bot would need to investigate

The elements of the query would be passed to the Complementary Inferers which will assess whether they can attempt inference. The Inferers will require full access to the user's uOnty, to be able to infer properly.

The end goal is to augment the user's original search query to get better results, but this needs to be done shrewdly as you need to add inferred elements in the right place, to prevent searches failing.

### Example

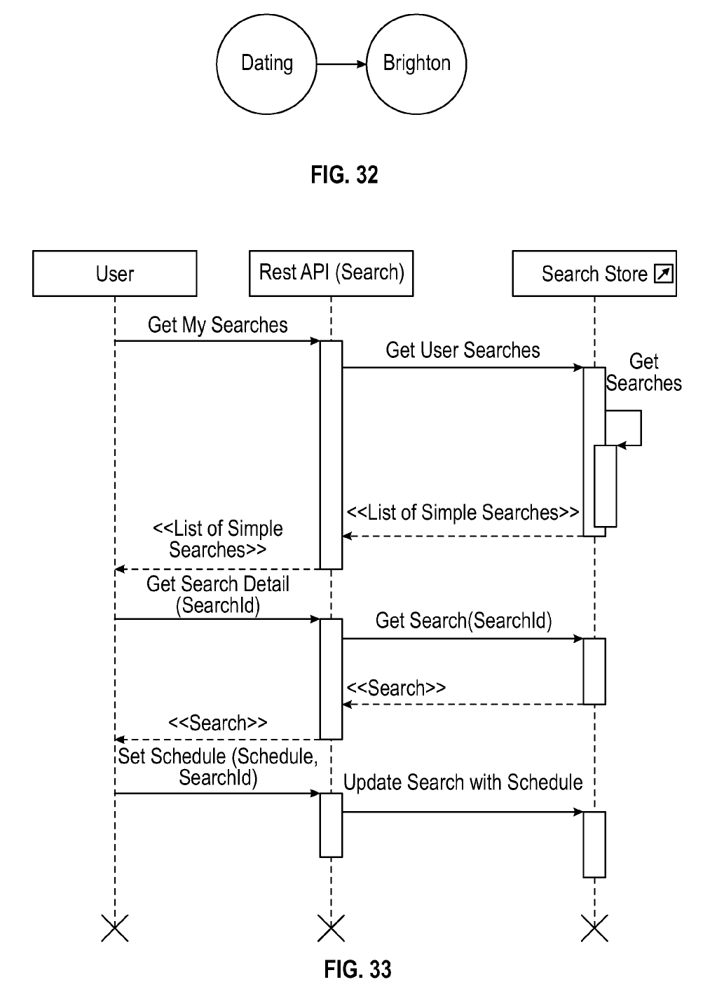

User A searches for elements as shown in FIG. 32.

The bot passes the query elements to the Complementary Inferers which assess whether or not they can infer anything. If the inferer can infer, it adds its inferences to the query.

The bot interprets the ‘INFERRED’ relationships as ‘RELATED_TO’ to allow matching to occur, and a search is made.

### Learning Bots

As bots are created independently of each other they can be written to do almost anything, learning is a big part of this, and the Onty system provides facilities to allow a bot to learn in a few ways.

### Bot Memory API

To learn, a bot should be able to remember. Bots themselves have no direct access to the file system and so need another way to store their memory. The system provides a Memory API which lets a bot save its state, or any other data it wants to.

The data is only readable by the given Bot, and should be in the form of a JSON object, but other than that there are no limitations.

### Feedback Based

Generally, bot learning will come from user interaction. A user will rate the results the bot has returned, and the bot can learn from the feedback how well it's doing. Ratings can be just on the results themselves—as soon as a user sees them, or it could be later, when a user has connected with someone, and discovered them to be either appropriate, or inappropriate.

### Example

A user searches for something with the element (Train) in it, the first time the bot returns a mixture of ‘train’ elements (train as in learning and train as in transport), and the user says the learning elements are invalid.

The bot remembers this, and over a period of time starts to promote ‘train-transport’ results over ‘train-learn’ results.

Of course, someone else could say the opposite, and the bot would react accordingly. There is nothing to stop a bot training itself for specific users, so it might only promote ‘train-transport’ for a particular user.

### Self-Learning (Natural)

This is a more complicated than feedback based learning, as it requires a bot to assess itself, this could be in the form of keeping track of the performance of its querying, the positioning of inferred elements etc.

### Example

A bot executes a query and finds it takes longer than a predefined timescale (defined by the bot-creator). The bot continues to execute the query, but also moves it to an ‘Analysis’ queue where it can analyse the query and see if it can improve the performance. This might be by maybe splitting it into two and running independent queries, or some other method.

The next time the bot receives a query it checks to see if has analysed something like it before, if it has (maybe by some metric as simple as the number of elements) then it may parse the query to see if it can search in a more efficient way.

### Long Term Search Triggers

A Long Term Search (LTS) is a search that is triggered on a schedule.

In a normal context—searches are instigated by a user. A user wants to search for something, they create their search, and execute it. For a LTS the initial steps are the same, but once the search has completed the search is saved and can then be periodically run. The system can cope with running a LTS from every minute to once a year (or even longer).

Once an LTS has been configured the user need not pay any attention to it until they get a notification that the search has completed and found a result (they can if they wish check the status of the search and see when it last ran at any time). The system will execute the search whenever schedule dictates.

It is entirely possible that a search might never return a match.

### Interface

The beginning interface is the same as for the normal search, once a search has been executed the user can then look at their search (via My Searches) and then set the schedule.

### Schedule Definition

The schedule only contains the information about the time to run the search, any other data (the content of the search for example) is all contained within the original saved query.

| Name | Type | Description |
|---|---|---|
| SearchId | Guid | The ID of the search the schedule is for. |
| DateFirstRun | DateTime | The date and time search was first executed. |
| Period | TimeSpan | A time span representing how often the search |
| | | should be executed. |

The sequence for the long term search is shown in FIG. 33.

### Sphere of Influence

The Sphere Of Influence (SOI) is a metric to improve (and rank) the results returned by a bot.

### Examples

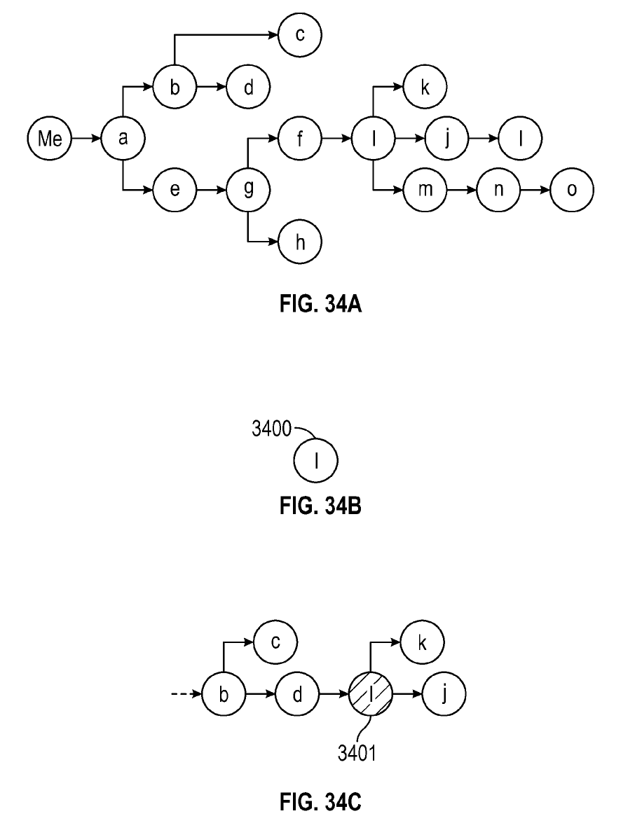

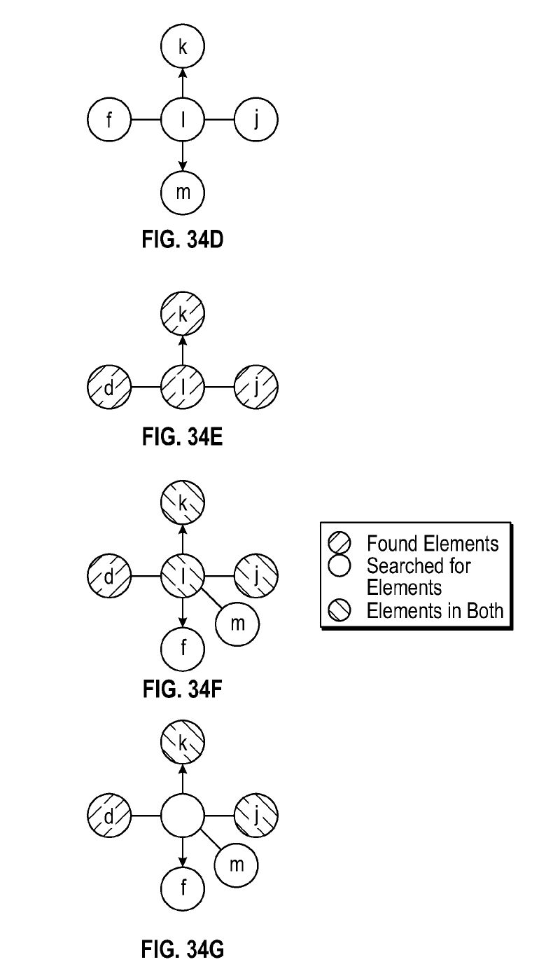

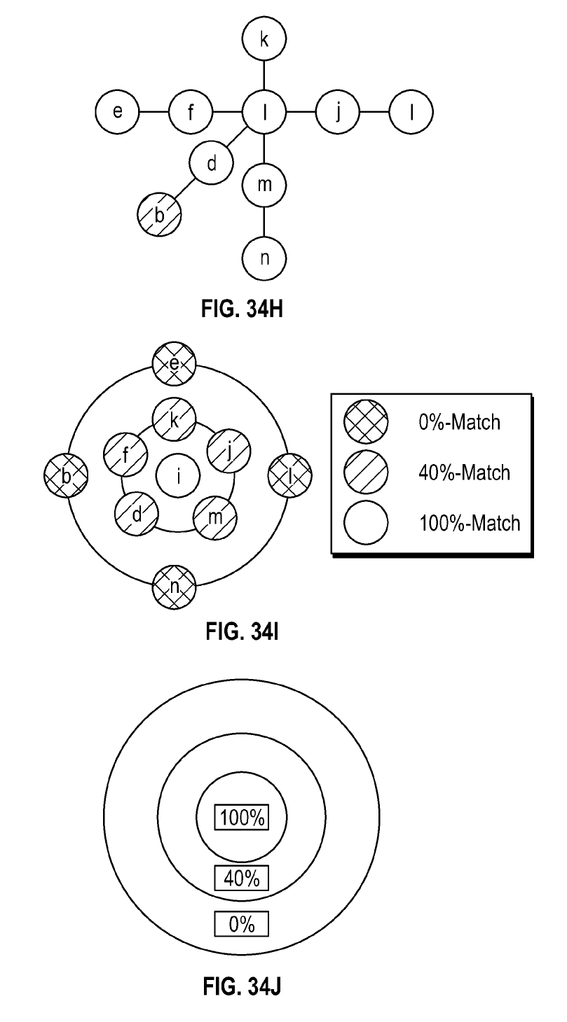

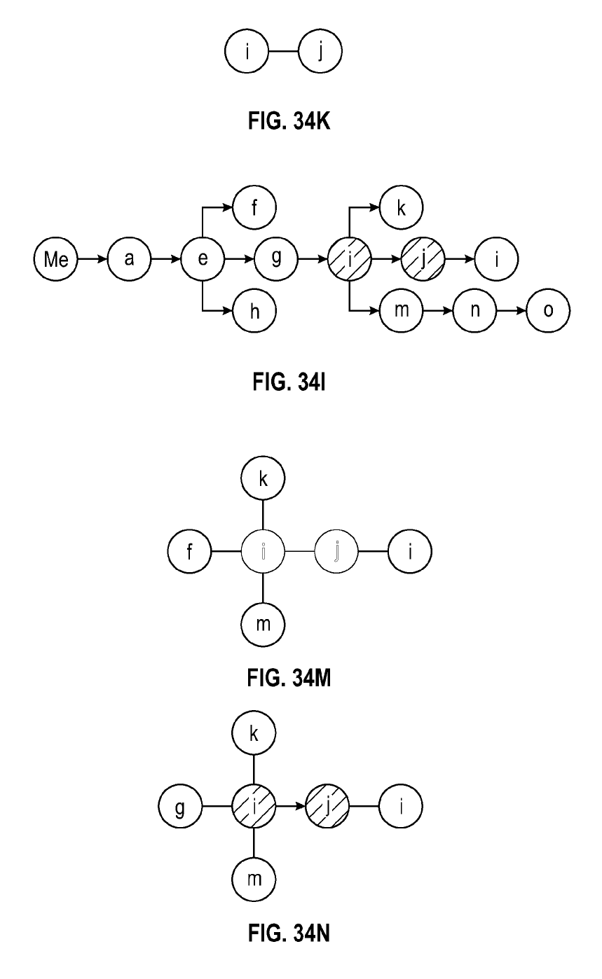

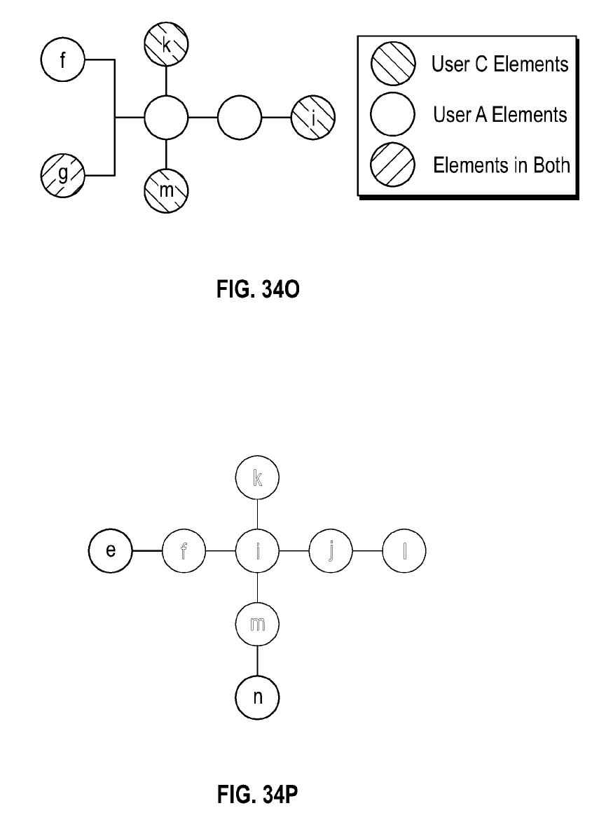

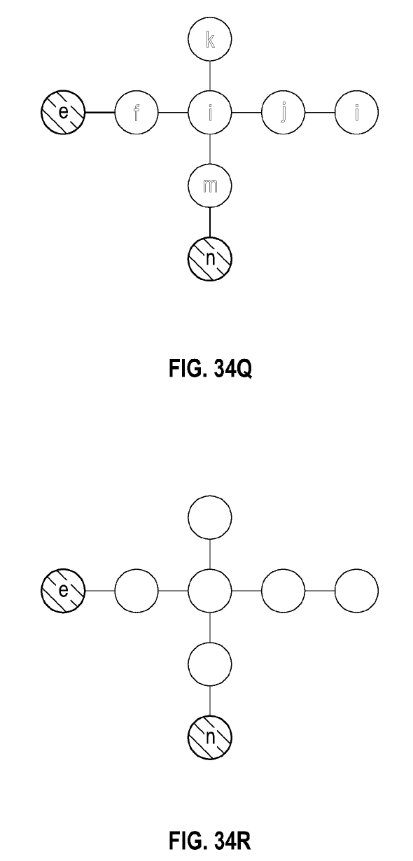

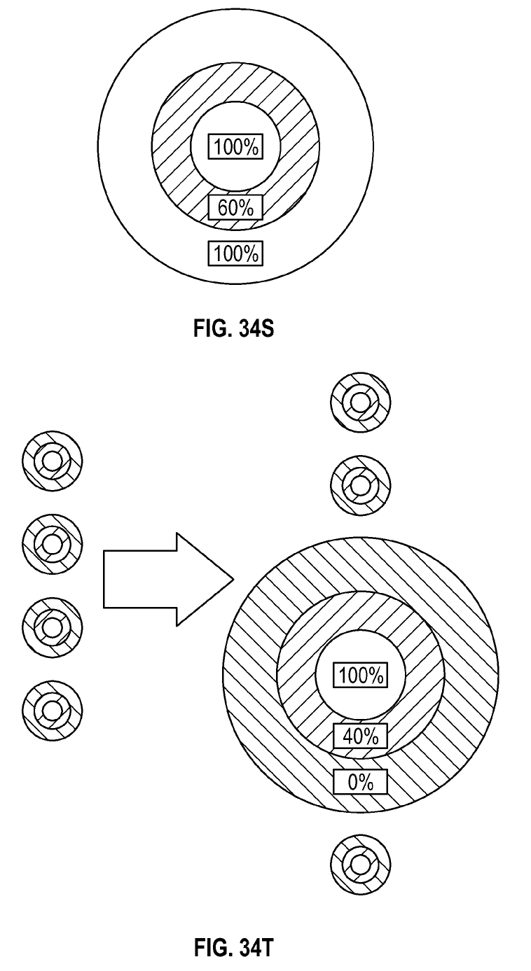

The following show basic examples of what the SOI calculates, in the examples, the user searching for others (User A) has the uOnty shown in FIG. 34a.

### Example 1—Single Search Item

In this example, the user searches for a single element. In practice this would be discouraged as the number of matches is likely to be so high that the results would be useless.

User A searches for the 3400 shown in FIG. 34b.

This matches against the equivalent element 3401 in another user's (User B) uOnty as shown in FIG. 34c.

The 3401 and 3402 give a 100% percent match, but the sphere of influence is designed to take into account surrounding elements.

If we look one node out (ignoring direction) we end up comparing User A's elements as shown in FIG. 34d.

To User B's elements as shown in FIG. 34e.

A combination of the two is shown in FIG. 34f.

Ignoring the central node, as we only care about the nodes one node out, we get the graph shown in FIG. 34g.

Of the 5 nodes, 2 are matches, and the other 3 are not shared. This gives us a score of: 2/5=0.4

We next examine the next nodes out (so 2 nodes out from the root search) as shown in FIG. 34h.

In this case, there are no common elements, so the rating is:

0/4=0

These can be displayed as circle representation as shown in FIG. 34i.

Or simpler as shown in FIG. 34j.

Allowing User A to see how close a match is.

### Example 2—Multiple Search Items

Multiple search items means that the circle representation as shown in FIG. 34j becomes slightly harder to calculate. In essence it works the same way as for single elements, but we take account of multiple starting points.

For this example, the user (User A) has searched for the elements shown in FIG. 34k.

And that has matched with a user's (User C) onty shown in FIG. 34l.

Again, we can ignore the initial ‘circle’ as that has a 100% match, and can concentrate on the nodes outside the initial match, so 1 node out:

For User A is shown in FIG. 34m.

For User C is shown in FIG. 34n.

And combined is shown in FIG. 340.

We have 5 elements, 3 of which match:

3/5=0.6

We then expand to 2 nodes out, for User A as shown in FIG. 34p.

For User C as shown in FIG. 34q.

In this case, we have a 100% match as shown in FIG. 34r.

So the circle diagram is as shown in FIG. 34s.

### Interpreting the Circle Diagram

Each ring represents a node out from the central (searched for) point. Generally the central point will always be 100% where a match has been made (potentially, some bots could provide matches based on partial matches).

Colours could be used to represent the match quality, allowing the diagram to be even smaller, with a mouse over showing details as shown in FIG. 34t.

At a glance you can see the quality of the match, the greener it is, the better the surrounding matches.

### Privacy

The circle diagram doesn't show to the searcher what the matches are, merely whether there are matches and what percentage of the surrounding elements are matches.

### Implementation

There are two ways to implement the SOI in the system.

### Implementation 1—Helper

The helper method involves putting an SOI calculator into the Match Bot Hoard, so that all results are parsed by it and the SOI is attached to any search.

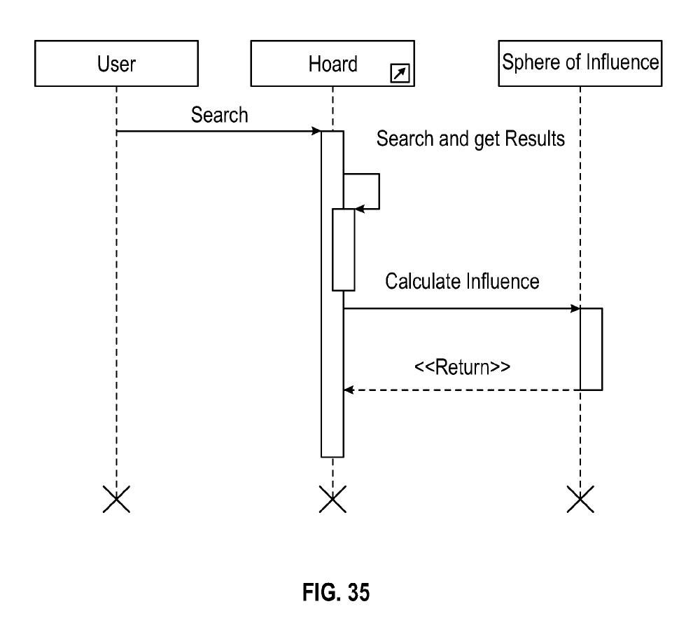

A Sequence Diagram is shown in FIG. 35.

### Implementation 2—Bot

The bot method involves creating a new Match Bot that takes in Results and outputs Results, in the process augmenting the results with SOI. The bot would need to be used in a Match Box form. This way allows a user to generate results without the SOI if they wish, as they could select bots without any SOI capability.

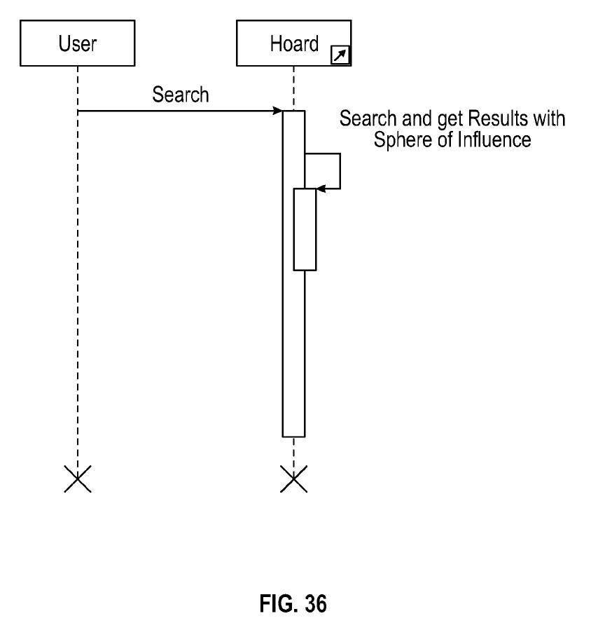

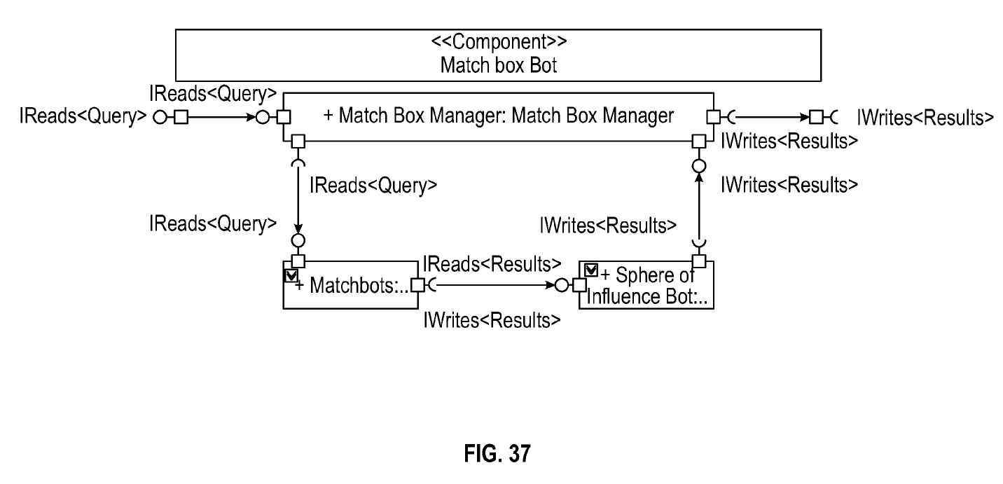

A Sequence Diagram is shown in FIG. 36 and a Component Diagram is shown in FIG. 37.
1. A query is passed to the MatchBox Bot
2. The query is passed to the first bot which performs its search and then outputs Results.
3. The Results are passed to the Sphere of Influence Bot which calculates the influence ratings for the Results, and augments the original results with the influence ratings.
4. The results are returned from the Sphere of Influence bot to the MatchBox Manager and are then passed outside the MatchBox Bot to the Hoard

### Data Design

The Sphere Of Influence values would be added to the Result objects returned from a search. The format would be Dictionary with a Key of Integer, and a value of Double. The key represents the number of nodes out from the centre, the value represents the actual SOI score.

| Name | Type | Description |
|---|---|---|
| SphereOfInfluence | IDictionary<int, | The scores for the matches. |
| | double> | |

### Relationships Between Nodes

Some embodiments of the system may also provide for the definition of different types of relationships between nodes.

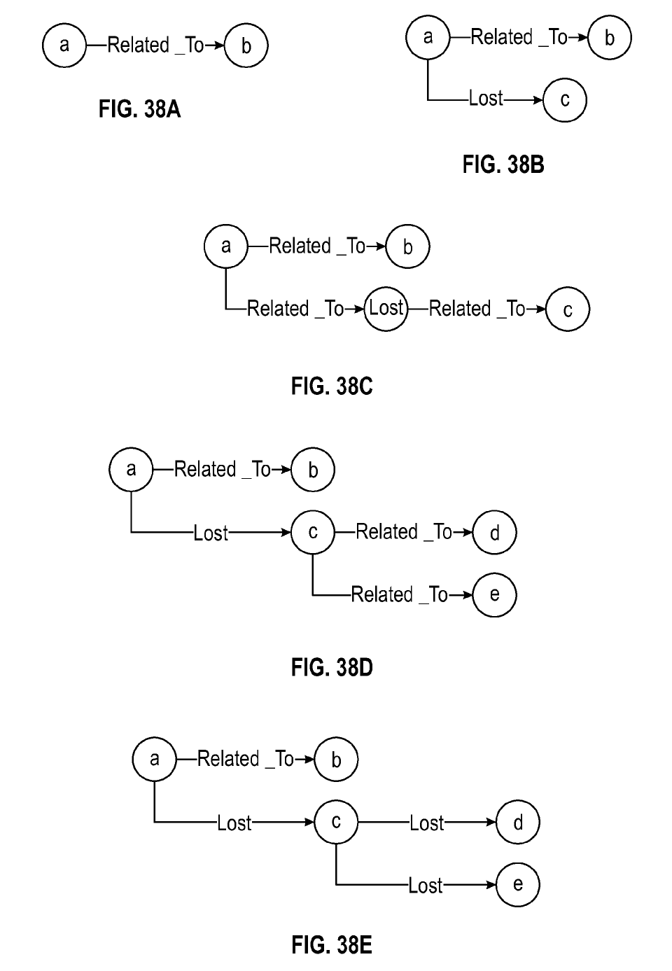

In these embodiments, a user can also set the type of their relationships, by default the relationship is ‘RELATED_TO’ as shown in FIG. 38a.

But a user can select from a predefined list of relationship types (including, but not exclusively):
Lost
Found
Personal
Want
Seek
Offer

Which results in the graph shown in FIG. 38b.

The LOST relationship type can be used as a substitute for using a separate node to indicate loss (as in FIG. 38c).

The relationship isn't needed (or indeed desirable) for subsequent elements as shown in FIG. 38d.

But there is nothing to prevent a user doing so, as shown in FIG. 38e, if they wish.

### Sequence Diagram

The sequence diagram for this is the same as the Create Onty Element diagram shown in FIG. 5.

### Data Type

The only difference between the existing Create data type would be the addition of a ‘Relationship’ property to the Create New UOE data type.

| Name | Type | Description |
|---|---|---|
| Value | String | The value entered by the user for this |
| | | Onty Element. |
| Relation- | String | The type of relationship to use. |
| shipFrom | | |
| LinkedFrom | Guid | The element this new one is to be attached |
| | | to (the previous/parent element). |
| IsHidden | Boolean | Whether the element is hidden (private) or not. |
| | | If true the element is private, false otherwise. |
| Data | DataEl- | Any data element information see 0 |
| | ement[ ] | |

### Search Bots

Use of different relationship types have an effect on the way search bots work, in particular generating queries would also contain the relationship information. So a query for two (or more) elements would have additional relationship elements defined.

Potential advantages of some embodiments of the present invention are that contextual search is made both possible and user-friendly within graph-based architectures; portions of existing graphs can be repurposed by the user as parameters for search; and anonymity within a social network application can be enforced for search.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method of searching in a set comprising a plurality of entities each entity comprising a graph of nodes containing information related to the entity, including:
i) receiving input at one or more processors from a user to define a plurality of related nodes;
ii) one or more processors searching one or more of the graphs by matching nodes of the one or more graphs to the defined nodes; and
iii) one or more processors retrieving one or more entities comprising matching nodes that exceed a threshold, or thresholds.

2. A method as claimed in claim 1, wherein the user defines the plurality of related nodes by selecting those nodes within a graph of a search entity.

3. A method as claimed in claim 1, wherein the user defines the plurality of related nodes by creating a connected graph comprising the plurality of related nodes.

4. A method as claimed in claim 1, further including the step of one or more processors displaying at least part of the one or more retrieved entities to the user.

5. A method as claimed in claim 1, wherein the graph is a tree hierarchy.

6. A method as claimed in claim 1, wherein an inference engine is used to match the nodes.

7. A method as claimed in claim 6, wherein the inference engine learns inferences between nodes and/or information contained within the nodes by analysing relevance of previous matches.

8. A method as claimed in claim 1, wherein the threshold is definable by the user.

9. A method as claimed in claim 1, wherein the threshold is applicable to every defined node.

10. A method as claimed in claim 1, wherein separate thresholds are definable for each defined node.

11. A method as claimed in claim 1, wherein the returned entities are displayed to the user in real-time.

12. A method as claimed in claim 1, wherein the defined nodes are modifiable during the search by the user by selected additional nodes or unselecting currently selected nodes.

13. A method as claimed in claim 1, wherein one or more of a plurality of matching engines are used to search for matching nodes.

14. A method as claimed in claim 13, wherein at least one of the matching engines is selected by the user.

15. A method as claimed in claim 13, wherein the matching engines include synonyms and translation engines.

16. A method as claimed in claim 15, wherein the synonym and/or translation engine use a frequency map.

17. A method as claimed in claim 13, wherein the matching engines are definable by the user.

18. A method as claimed in claim 13, wherein the matching engines includes one or more parameters definable by the user.

19. A method as claimed in claim 1, wherein the entities represent individuals.

20. A method as claimed in claim 1, wherein the search entity represents the user.

21. A method as claimed in claim 1, wherein nodes are matched using both complementarity and similarity.

22. A method as claimed in claim 1, wherein at least some of the information contained within the graphs of the entities is not accessible to the user unless retrieved by the one or more processors as a result of matching nodes.

23. A system for searching in a set comprising a plurality of entities each comprising a graph of nodes containing information related to the entity, including:
One or more user devices comprising an input and a display;
One or more processors configured receiving input at one or more processors from the user device to define a plurality of related nodes, for searching one or more of the graphs by matching nodes of the one or more graphs to the defined nodes and one or more processors retrieving one or more entities comprising matching nodes that exceed a threshold, or thresholds; and
One or more memory configured for storing graphs of nodes representing a plurality of entities.
